(19) United States
(12) Patent Application Publication
(10) Pub. No.: US 2008/0109115 A1
(43) Pub. Date: May 8, 2008

(54) Dynamic force controller for multilegged robot

(76) Inventor: Michael Zin Min Lim, Playa Del Rey, CA (US)

Correspondence Address: PATTI, HEWITT & AREZINA LLC, ONE NORTH LASALLE STREET, 44TH FLOOR, CHICAGO, IL, 60602, US

(21) Appl. No.: 11/592,667

(22) Filed: Nov. 3, 2006

(51) Int. Cl. G05B 13/00

(52) U.S. Cl. 700/258; 700/260; 901/1

(57) ABSTRACT

A force controller for a multi-legged robot operating in low-, micro-, or zero gravity environments, and using adhesive foot pads for removable attachment of the feet to a supporting surface or object, dynamically balances all external forces on the robot using a least squares technique, while observing predefined system constraints. The controller decomposes otherwise indeterminate least squares problems into plural individual problems involving fewer forces or controlled parameters, which problems are determinate, and then combines the results using superposition to produce a solution for the entire robot. Where system constraints, such as limits on footpad adhesion, prevent the controller from perfectly balancing all external forces, the residual unbalanced forces will cause some movement of the robot body that deviates from the intended movement or position profile. The controller continues to balance forces over time, such that the movement/position error decays to a minimal amount.

### STATEMENT OF GOVERNMENT RIGHTS

This invention was made with Government support under Contract No. NNA05BE51C. The government has certain rights in this invention.

### TECHNICAL FIELD

This invention relates generally to control systems for robots, and more particularly to control systems for providing dynamic control of a multi-legged robot adapted for use in low- or zero-gravity environments, which robot may execute asymmetrical gait and environmental loading operations while observing dynamic force/movement constraints.

### BACKGROUND

Although engineered and manufactured to provide high reliability, spacecraft and ancillary equipment sometimes require inspection and maintenance even after such items have been transported to a location in space and placed into service. In recent years, several human spaceflight missions of the United States have notably included inspection and maintenance tasks to be performed by astronauts. Human spaceflight carries significant risk to astronauts, is costly, and is extremely limited in capacity. In addition, it may not always be possible to employ astronauts to perform a particular inspection and maintenance mission. For example, the object to be inspected or maintained may not be accessible by space vehicles currently available to human spaceflight programs, or the inspection or maintenance task may expose astronauts to unacceptable danger.

Accordingly, there has been a desire to develop remotely operated or autonomous systems for inspecting and maintaining space vehicles and ancillary equipment. An autonomous walking inspection and maintenance robot (AWIMR) has been proposed that could perform inspection and maintenance tasks in low-, micro-, or zero-gravity space environments. The robot would have a plurality of jointed “legs” for ambulating over a generally arbitrary path on the surface of the object of interest, such that, in general, the object need not have special fixtures to accommodate the robot. The legs terminate in “foot” pads having an adhesive surface for removably attaching the foot pads to the object surface and for providing tractive coupling thereto. The robot moves by detaching one or more legs (but not all simultaneously) from the surface, singly or in groups, moving the legs to a new position, reattaching the foot pads to the surface, and repositioning the body with respect to the legs.

The movement of a robot in low-, micro-, or zero-gravity environments presents special challenges not generally encountered in connection with terrestrial robots. The availability of gravity as a restorative force greatly aids the control of a conventional terrestrial robot. No adhesive is generally needed because gravity urges the robot's feet into contact with the surface, usually with sufficient force that adequate traction is maintained. There is no risk that the robot will separate from the surface. Accordingly, conventional controllers for terrestrial robots have generally been “position controllers.” Such controllers generate a command describing the desired body position; a controller associated with each individual leg is permitted to determine its own movement solution independent of the other legs. Such controllers position the legs in a manner that ultimately results in a desired static position of the legs and the robot body, but generally do not attempt to control the forces applied by the legs or dynamically balance the forces on the legs and the body. For example, if a single leg is to be removed from the surface as part of an ambulation step, it is not generally necessary to carefully control the forces applied by the other legs as long as there is sufficient force to avoid collapse of the legs, and, in fact, the other legs can be locked in position.

This is not the case for a robot operating in a low- or zero-gravity environment. Adhesive or some other engagement with the surface is required to avoid separation of the robot from the object and to enable traction. The adhesive or engagement action must generally be removable to allow the feet to be repositioned to permit ambulation. However, both adhesion and traction are limited, and not perfectly predictable, as the adhesive performance may vary with temperature, surface characteristics, and other parameters. Unless the forces and moments applied to or by the robot are carefully controlled, it is possible that the robot foot pads could be unintentionally detached from the surface, causing the robot to skid along the object surface or to separate from the object. Skidding could cause damage to the object or the robot, and separation could result in such damage, or loss of the robot. In addition to forces and moments associated with intentional ambulation of the robot, the robot may be equipped with one or more “end-effectors” which are essentially tools that may be positioned into contact with an object, engage a part thereof, and apply a force or moment thereto. Such forces or moments could also overcome adhesion or traction, exceed actuator parameters, or cause undesired movement of the robot body. (Hereafter, non-quantitative references to “force” or “forces” are intended to also incorporate “moment” or “moments” unless otherwise specified or the context requires.) The challenge of controlling a robot in such an environment is exacerbated by the presence of certain freely moving joints which lack an actuator, clutch, or locking mechanism in one or more directions.

### SUMMARY

A movement/force controller for a multi-legged robot operating in low-, micro-, or zero-gravity environments includes a control system, facilities for establishing a desired command profile for position and movement of the robot body and legs, output facilities for delivering force or moment commands to the robot's actuators, and input facilities for receiving sensor information describing the state of the robot, any limbs, and any “end effectors,” other external tools, and other devices by which the robot may impart force or moment with respect to external objects.

The command profile may include linear position, velocity and acceleration, and angular position, velocity, and acceleration, for each leg, and for the robot body. The components needed in the command profile may vary depending on the configurations of the robot, its limbs, and actuators. The command profile defines a planned set of robot operations, which may include movement of the robot body or limbs, and the movement and operation of end effectors. The robot state may include the position of the robot (or information from which that position may be derived), the positions of the limbs, joints, or other peripheral elements of the robot (or information from which that position may be derived), force or moment measurement information from limbs or other externally-acting devices, and rate-of-change or other information which may be derived or integrated from any of the aforementioned sensed parameters.

The controller includes a state-determining component which receives sensor information and determines position and orientation of the robot, its limbs, joints, and optionally other externally active components. The state-determining component may also determine one or more related derived parameters from the sensor information or determined positions or orientations. These “related derived parameters” may include without limitation rate-of-change information with respect to any parameter, and any other derivatives or integrals of those parameters. The controller further includes a force/moment determining component which receives the state information from the state-determining component, and optionally, external force information from force sensors, and determines the external forces and moments acting on the robot body and limbs. The controller further includes a component responsive to the force/moment information and the command profile to determine an optimized state profile (which may include forces and moments), with respect to the robot body center of mass, required in order to optimally execute the intended command profile while remaining within prescribed system constraints. These constraints may be dynamic, physical, or policy constraints, and may include, for example, limits on the adhesive attachment force by which the robot's feet are attached to a supporting surface or object. The controller further includes a component which is responsive to the optimized state profile with respect to the robot body center of mass, and which determines corresponding optimal limb state commands (e.g., forces, moments, etc.), to be applied to each of the legs of the robot. Each optimal limb state command is determined in the frame of reference of the corresponding leg, such that, when the state commands for all legs are combined, they are equivalent in effect to the optimized state profile determined for the robot as a whole in the center of mass frame. Corresponding commands, which may be leg force commands, are applied to the actuators of the robot, possibly through intermediate, low-level controllers. Although the several components which comprise the controller are mentioned as separate elements, they may be integrated or refactored as needed to suit other constraints.

According to related methods, the controller employs a least squares technique to determine forces in a way that optimally and dynamically balances all of the external forces acting on or imparted by the robot, while observing predefined system constraints. The dynamic balancing occurs whether the robot is executing a movement operation, or is attempting to suppress or settle movement, such as when a movement is complete or the robot's end-effector is used to work on an external object. It is not always possible to perfectly balance the dynamic forces while observing the applicable system constraints. The controller's solution observes the system constraints, at the expense of initially producing small residual unbalanced forces which result in movement of the robot body or of allowing small deviations from the intended path, position, orientation or other parameters as defined in the command profile. The controller then attempts to continuously balance the external forces over time, such that the residual unbalanced forces shortly decay to minimal amounts.

The term “balancing forces” is used herein to refer to controlling any forces and moments which the robot may impart to the environment, including without limitation those imparted by any of the robot's limbs on any supporting surfaces, and those imparted by any end effectors, such that the net forces and moments, on the robot body or on a coordinated system of limbs of the robot, closely approximate a set-point defining intended net forces and moments on the robot (or related coordinated system), such as those selected in the command profile. Non-quantitative references to “force” or “forces” are intended to also incorporate “moment” or “moments” unless otherwise specified or the context requires. When the forces imparted by the robot are controlled such that, in combination with the other external forces on the robot, they closely approximate a set-point defining intended net forces on the robot, the forces are said to be “balanced”. The controller is often unable to issue control commands that would cause the robot to exactly conform to a set-point defining intended net forces on the robot, because such commands may cause the robot to exceed certain constraints, such as foot-pad adhesion, actuator limits, and the like. Accordingly, the controller determines optimal commands that balance forces while minimizing error or difference between the intended value of a parameter and the control commands issued to control that parameter. “Closely approximate” is intended to mean that the error or difference between the intended value of a parameter and any commands issued by the controller to control that parameter is on the order of the error or difference produced using a least-squares error minimization method.

In determining the least square force/moment solution for a robot subject to a plurality of external forces, it is not always possible to incorporate all of the controllable parameters for all of the legs and forces simultaneously, because redundancy renders the least squares problem indeterminate. The controller resolve this situation by decomposing the system into a plurality of individual least square problems using a number of forces and a controllable parameter geometry selected to ensure that each least square problem is determinate. Then the controller uses superposition to combine the force/moment results from the individual problems to obtain a solution for the entire system.

The controller and associated methods advantageously provide improved safety and stability of the robot, minimizing or eliminating the risk that force applied by the robot to one leg will cause the inadvertent detachment of other legs. In addition, the controller and associated methods provide improved stability for a robot traversing uneven or irregular surfaces. Further, the controller and associated methods can balance essentially all external forces (within mechanical limits) including those not arising from the robot's intentional travel. For example, forces arising from use of the robot's end-effector tool may be dynamically balanced, providing improved safety and stability.

### DESCRIPTION OF THE DRAWINGS

Features of example implementations of the invention will become apparent from the description, the claims, and the accompanying drawings in which:

FIG. 1 is a block diagram of an example movement and force controller 100 constructed according to an aspect of the present invention as it may be applied to an autonomous walking inspection and maintenance robot (AWIMR) 150 intended for use in a low-, micro-, or zero-gravity space environment;

FIG. 2 is a simplified mechanical schematic diagram of a first example embodiment 210 of an AWIMR-type robot having six legs, with which a movement/force controller 100 constructed according to the present invention may be used, shown in plan view;

FIG. 3 is a simplified mechanical schematic diagram of a second example embodiment 310 of an AWIMR-type robot having four legs, with which a movement/force controller 100 constructed according to the present invention may be used, shown in plan view;

FIGS. 4 is a partial perspective view of the first example embodiment 210 of a robot of the type with which controller 100 may be used, taken from a position elevated and displaced from the center, showing a particular configuration of forces on the legs of the robot;

FIGS. 5 is a partial perspective view of the first example embodiment 210 of a robot of the type with which controller 100 may be used, taken from a position elevated and displaced from the center, showing a different configuration of forces on the legs of the robot;

FIGS. 6 is a partial perspective view of the second example embodiment 310 of a robot of the type with which controller 100 may be used, taken from a position elevated and displaced from the center, showing a particular configuration of forces on the legs of the robot;

FIGS. 7 is a partial perspective view of the second example embodiment 310 of a robot of the type with which controller 100 may be used, taken from a position elevated and displaced from the center, showing a different configuration of forces on the legs of the robot;

FIG. 8 is a graph depicting a typical jerk-limited linear or angular acceleration command or profile 810, which may be used by the controller 100 to bring a robot having non-zero initial velocity to a zero final velocity condition;

FIG. 9 is a graph depicting a typical jerk-limited linear or angular acceleration command or profile 810, which may be used by the controller 100 to bring a robot having a zero initial velocity to a desired velocity, and then back to a zero final velocity condition;

FIG. 10 is a table identifying a sequence 1000 of method steps which may be used to execute an asymmetric, single-leg gait for the quadrupedal robot 310 of FIGS. 3 and 6-7, as may be performed by a controller 100 constructed according to the present invention.

FIG. 11 is a simplified mechanical schematic diagram of a quadrupedal robot body 312 and legs, shown in plan view, and depicting an initial stage in the series of steps 1000 of FIG. 10, as may be performed by controller 100 to achieve ambulation of the robot using an asymmetric, single-leg gait;

FIG. 12 is a simplified mechanical schematic diagram of a quadrupedal robot body 312 and legs, shown in plan view, and depicting a subsequent stage in the series of steps 1000 of FIG. 10, as may be performed by controller 100 to achieve ambulation of the robot using an asymmetric, single-leg gait;

FIG. 13 is a simplified mechanical schematic diagram of a quadrupedal robot body 312 and legs, shown in plan view, and depicting a subsequent stage in the series of steps 1000 of FIG. 10, as may be performed by controller 100 to achieve ambulation of the robot using an asymmetric, single-leg gait;

FIG. 14 is a simplified mechanical schematic diagram of a quadrupedal robot body 312 and legs, shown in plan view, and depicting a subsequent stage in the series of steps 1000 of FIG. 10, as may be performed by controller 100 to achieve ambulation of the robot using an asymmetric, single-leg gait;

FIG. 15 is a simplified mechanical schematic diagram of a quadrupedal robot body 312 and legs, shown in plan view, and depicting a subsequent stage in the series of steps 1000 of FIG. 10, as may be performed by controller 100 to achieve ambulation of the robot using an asymmetric, single-leg gait; and

FIG. 16 is a simplified mechanical schematic diagram of a quadrupedal robot body 312 and legs, shown in plan view, and depicting a subsequent stage in the series of steps 1000 of FIG. 10, as may be performed by controller 100 to achieve ambulation of the robot using an asymmetric, single-leg gait.

### DETAILED DESCRIPTION

FIG. 1 is a block diagram of an example movement and force controller 100 constructed according to an aspect of the present invention as it may be applied to an autonomous walking inspection and maintenance robot (AWIMR) 150 intended for use in a low-, micro-, or zero-gravity space environment.

The controller 100 is described herein in the application environment of an AWIMR robot, by way of example but not limitation, to show how challenges encountered in controlling a robot in that environment may be overcome using the teachings of the present invention. However, one of skill in the art will appreciate that the controller 100 could also be advantageously applied to many other types of robots, and more generally to other moving vehicles, devices, and objects, in environments not limited to low-, micro-, or zero-gravity space environments, without modification or with modifications within the ken of a person of skill in the art, consistent with the spirit of the invention.

The present application relates to control systems, which may be implemented using a variety of electronic and optical technologies, including but not limited to: analog electronic systems; digital electronic systems; microprocessors and other processing elements; and software and otherwise embodied collections of steps, instructions, and the like, for implementing methods, processes, or policies in conjunction with such systems and processing elements. It will be appreciated that in the control system arts, various signal leads, busses, data paths, data structures, channels, buffers, message-passing interfaces, and other communications paths may be used to implement a facility, structure, or method for conveying information or signals, and are often functionally equivalent. Accordingly, unless otherwise noted, references to apparatus or data structures for conveying a signal or information are intended to refer generally to all functionally equivalent apparatus and data structures.

As best seen in FIG. 1, the movement/force controller 100 is coupled to a group 130 of conventional robot “leg” controllers, which, in turn, is coupled to the robot 150 itself.

Robot 150 is preferably “independently mobile” in the sense that it is preferably not permanently affixed to a surface or structure, but is free to move, in gross, along a surface or structure. As best seen in FIGS. 2-6, examples 210 and 310 of robot 150 comprise a body and a plurality of jointed legs. Joints have various degrees of freedom. Some joints may have coupled thereto one or more powered actuators for imparting a force or moment in a selected direction, which may include an angular direction. In some robots, some joints may have coupled thereto one or more controllable locks or clutches which can be commanded to prevent movement in selected directions but do not independently supply force or moment. Although, the particular example robots described herein are not equipped with such controllable clutches or locks, the controller 100 could be used with robots that have them. Some joints may lack actuators or locks, or clutches, and therefore permit free movement in the directions of the joint until mechanical limits are reached. Although robot 150 is described herein with jointed legs, the movement/force controller 100 could also be used to control robots having wheels, tracks, and other means of movement or ambulation.

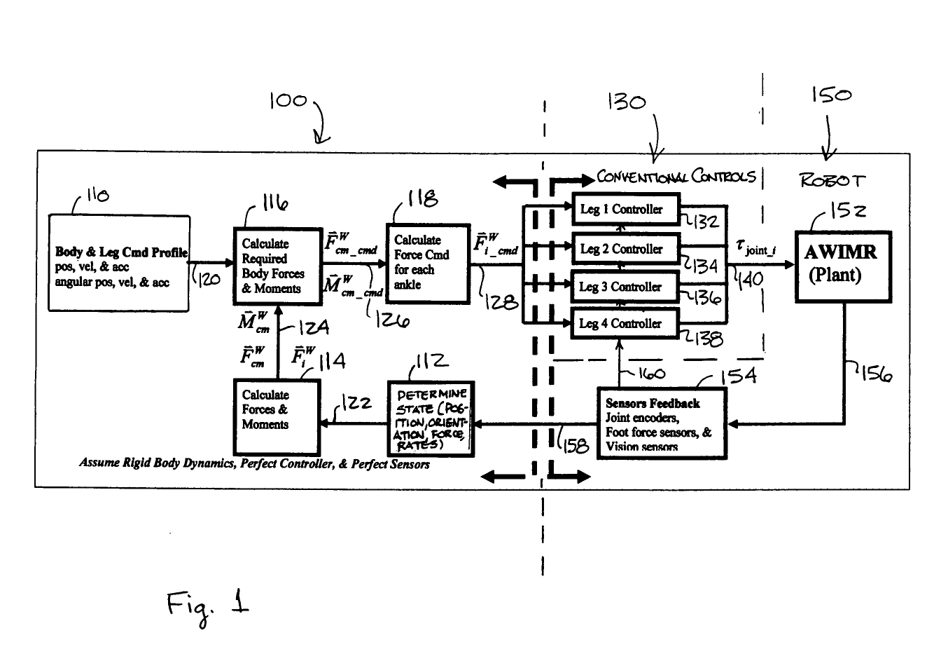

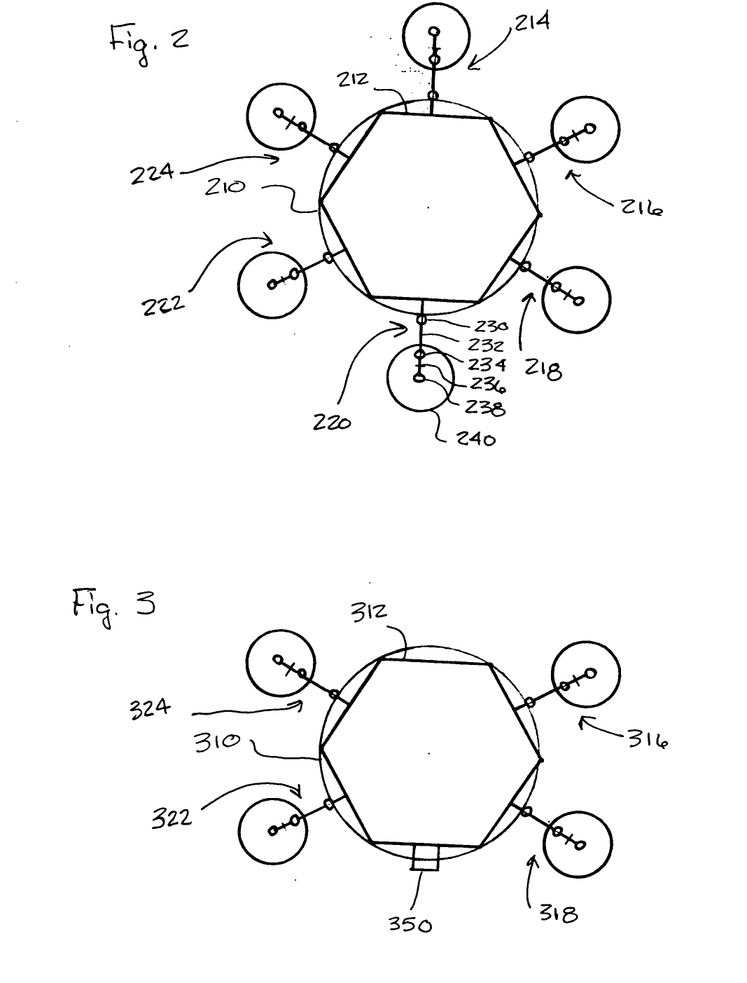

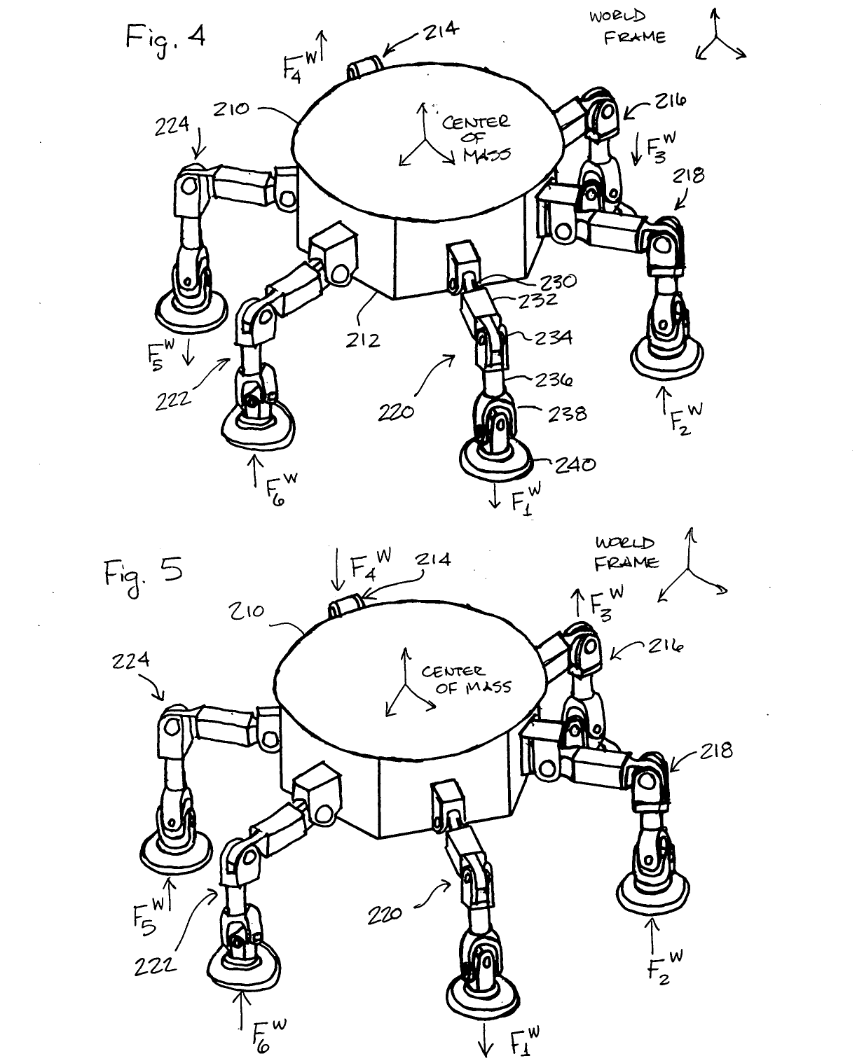

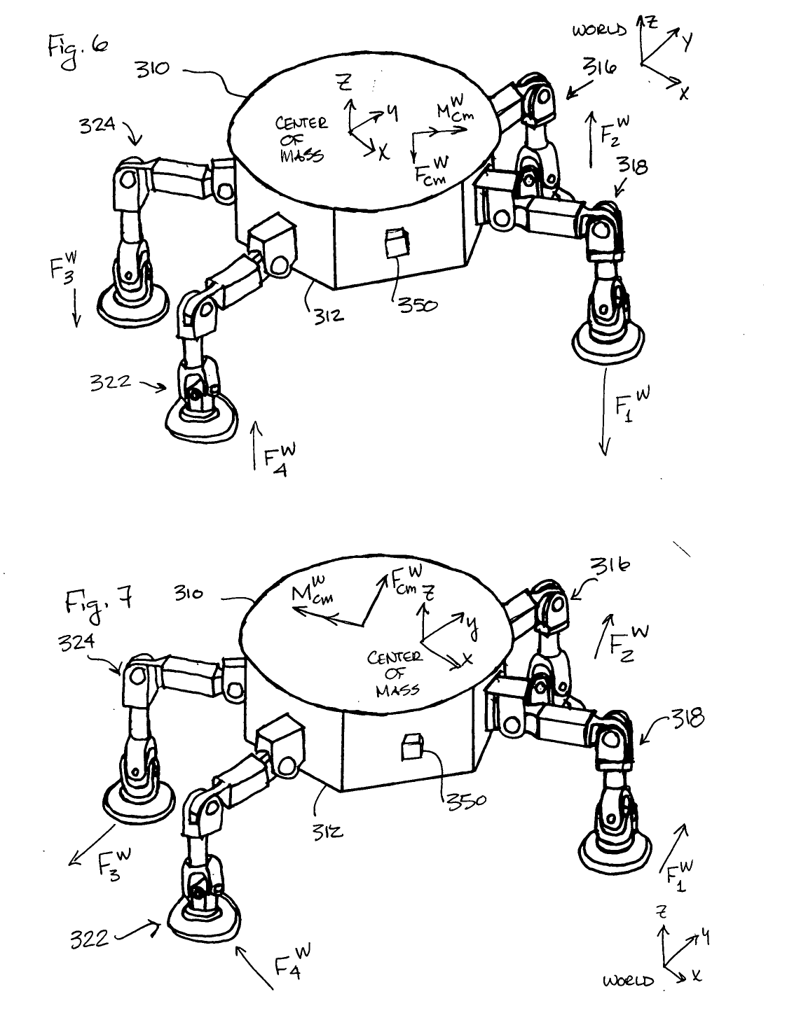

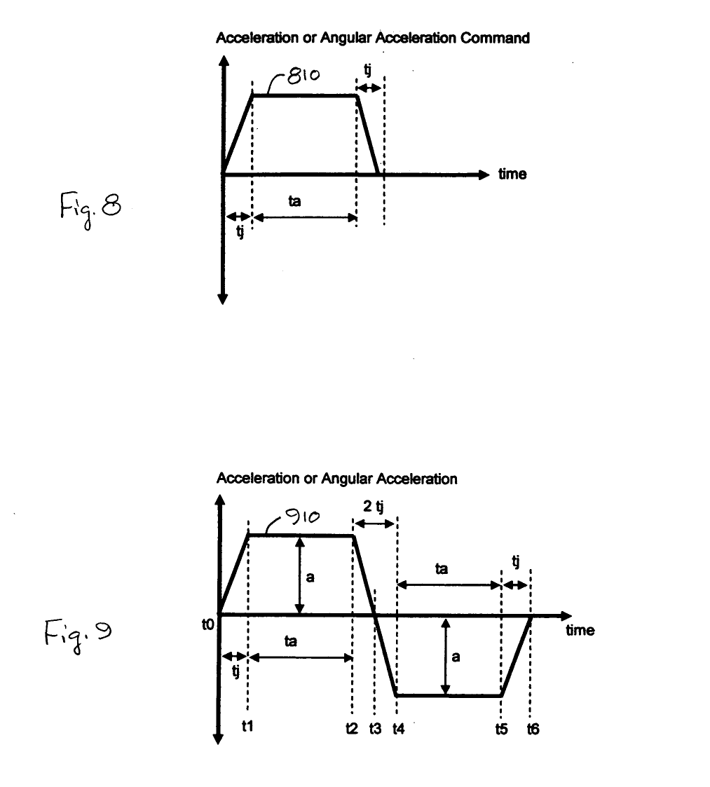

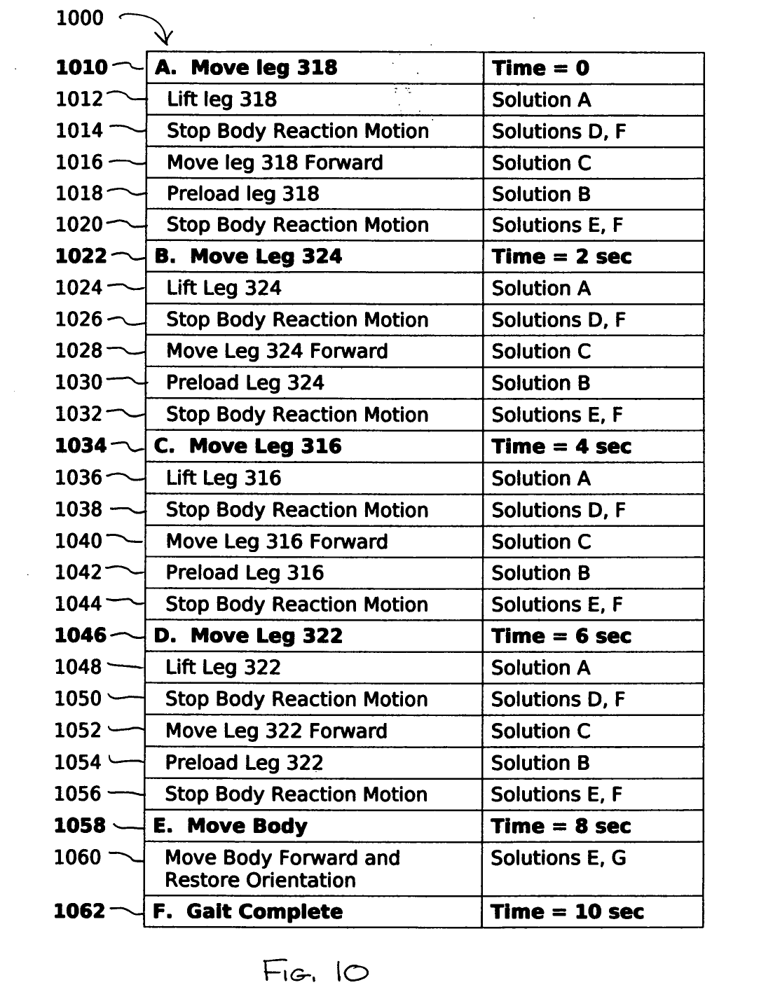

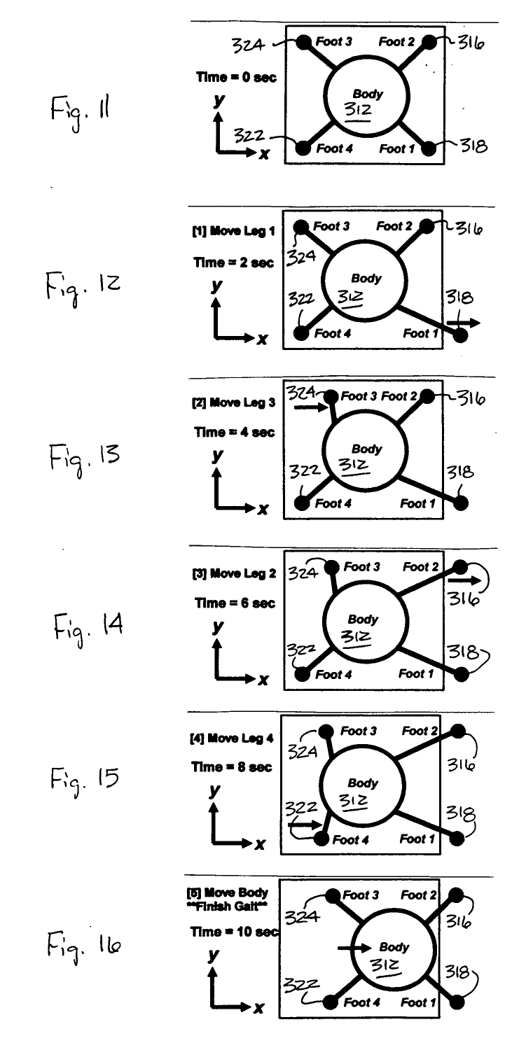

FIG. 2 is a simplified mechanical schematic diagram of a first example embodiment 210 of an AWIMR-type robot with which a movement/force controller 100 constructed according to the present invention may be used, shown in plan view. As best seen in FIG. 2, the first example robot 210 is a six-legged robot. FIGS. 4-5 are partial perspective views of the first example robot 210 taken from a position elevated and displaced from the center. As best seen in FIGS. 2, and 4-5, robot 210 has a body 212 having a generally regular hexagonal cross-section. Six legs 214, 216, 218, 220, 222, and 224 extend from the respective faces of the body 212.

Each of the legs is preferably of similar construction. The components of leg 220 are described here by way of example using terminology analogous to human anatomy. A “hip” joint 230 couples a “thigh” structural element 232 to a corresponding face of the body 212. The hip joint 230 allows angular movement about an axis horizontal as depicted in the figure and parallel to the face. A “knee” joint 234 couples the thigh structural element 232 to a “shin” structural element 236. The knee joint 234 allows angular movement about an axis horizontal as depicted in the figure and parallel to the face.

An “ankle” joint 238 couples the shin structural element 236 to the foot pad 240. The ankle joint 238 effectively functions as a ball joint permitting angular movement about a pivot in any direction, subject to mechanical interference. Although the ankle joint 238 functions as a ball joint, it may be implemented as a universal joint or some other similar mechanical structure. Hip joint 230 and knee joint 234 are equipped with actuators for powered movement under control of the movement/force controller 100. Ankle joint 238 lacks an actuator, lock, or clutch mechanism. Therefore, the ankle joint 238 cannot be used directly to impart a moment on the foot.

The foot pad 240 preferably includes a suitable adhesive on the underside for removable attachment to a surface. Any adhesive suitable for removable attachment to the surfaces and environmental conditions with which robot 210 must be compatible may be used, including but not limited to microfilament mechanical structures that exhibit adhesive properties. The adhesive attachment preferably also provides tractive properties allowing the feet to experience sheer forces or moments without skidding across the surface to which it is attached.

The six-legged example robot 210 of FIGS. 2, and 4-5 has the advantage of being capable of ambulating by executing a symmetrical gait in a low-, micro-, or zero-gravity space environment where adhesive foot pads are used. However, due to the presence of a leg on each of the faces of the robot body, the six-legged configuration does not accommodate end-effector tooling on the side faces of the robot body. By omitting a diametrically opposing pair of legs, a four legged robot may be constructed having room for end-effector tooling on one or two of the side faces that formerly supported the omitted legs.

FIGS. 3 and 6-7 depict an example four-legged robot 310 with an end-effector tool on the front-most side face of the body. When operating a four-legged robot in a low-, micro-, or zero-gravity space environment where adhesive foot pads are used to provide a removable attachment to a surface, it is not safe to move multiple legs at once, because the forces required to preload each moved foot to enable adhesive attachment of the foot to the surface can cause the remaining feet to become detached. Accordingly, the four-legged robot must employ an asymmetrical, one-leg-at-a-time gait for ambulation.

FIG. 3 is a simplified mechanical schematic diagram of a second example embodiment 310 of an AWIMR-type robot with which a movement/force controller 100 constructed according to the present invention may be used, shown in plan view. As best seen in FIG. 3, the second example robot 310 is a four-legged robot. FIGS. 6-7 are partial perspective views of the second example robot 310 taken from a position elevated and displaced from the center. As best seen in FIGS. 3 and 6-7, robot 310 has a body 312 having a generally regular hexagonal cross-section. Four legs 316, 318, 322, and 324 extend from the respective faces of the body 312. An end-effector tool 350 is provided on the front-most face of the body 312. Each of the legs 316, 318, 322, and 324 of example robot 310 is preferably of similar construction to leg 220 of FIG. 2.

Returning to FIG. 1, the group 130 of conventional robot leg controllers receives optimized limb state command signals over path 128 from the movement/force controller 100 describing state variable parameters to be implemented by each limb. For example, to control a robot 212, 312 of the configurations shown in FIGS. 4-7, the optimal limb state command would preferably include parameters describing force to be applied at the “foot” or “ankle” of each robot leg. Each of the conventional leg controllers 132, 134, 136, and 138 processes the command for a respective leg and generates appropriate signals to drive the actuators of such leg, which signals are conveyed to the robot 150 via path 140. Any suitable actuators may be used, including electrical, pneumatic, hydraulic, or other actuators. The signals provided via path 140 may be any suitable signals, and may drive the actuators directly or may drive a valve, relay, or other transducer that controls or modulates power to the actuators. The group 130 of conventional robot leg controllers optionally also receives sensor information via path 160 from sensors 154. The sensor information, which may include without limitation position, orientation, rates, force, proximity, and similar parameters, provides feedback information that improves the ability of the conventional controllers to control actuators or other field/plant apparatus.

Conventional leg controllers 132, 134, 136, and 138 are depicted herein as separate from movement/force controller 100 to illustrate conceptually that such devices are known in the art. However, in a physical embodiment, the conventional controllers could be integrated into the same apparatus as controller 100. As best seen in FIG. 1, the conventional leg controller group 130 comprises four controllers to operate a robot having four legs. However, more or fewer controllers could be used to operate robots having different numbers of legs. Although the controllers 132, 134, 136, and 138 are shown as separate elements, in a physical embodiment the controllers may be integrated into the same apparatus.

As best seen in FIG. 1, the robot 150 preferably comprises a physical plant 152 coupled to the group 130 of conventional controllers via path 140, and group of sensors 154. The sensors group 154 preferably includes joint position encoders and foot force sensors for each of the robot legs. The sensors group 154 may also include force sensors for sensing external forces applied to the feet or the end effectors, vision sensors, other optical distance or position sensors, radar sensors, inertial sensors, GPS sensors, and any other appropriate sensor that may be used to provide feedback to controller 100 as to position or angle of the robot, or of a leg or joint thereof, or the rate of change of such parameters, or similar derivative values. Path 158 conveys sensor feedback from sensors group 154 to controller 100. Although the sensors group 154 is depicted as a component separate from the robot physical plant 152, in a physical embodiment, sensors are most likely to be integrated into the robot, adjacent actuators or joints, and path 156 reflects the flow of information from the robot physical equipment to the sensors.

As best seen in FIG. 1, the movement/force controller 100 comprises an element 110 for establishing a body and leg command profile based on established parameters for a particular task, such as a cycle of ambulation using a predefined gait or remaining in a defined position while experiencing external forces resulting from the use of an end-effector tool. The term “external force” includes all of the forces and moments imparted by or acting on the robot with respect to its external environment. External force includes without limitation: gravity; forces resulting from footpad adhesion; any forces imparted by or acting on the robot's legs with respect to a supporting surface, such as forces imparted on the environment to accelerate the robot body or a limb; and any forces imparted by or acting on the robot's end effector. The command profile preferably includes intended linear positions, velocities, and accelerations, and intended angular positions, velocities, and accelerations, for each leg and for the body of the robot 150. The command profile may also include intended forces to be applied by the robot to the external environment, e.g., via an end effector tool. The command profile may be continuously time-varying, and may vary dynamically. The command profile defines a planned or intended set of one or more robot operations, which may include intended movement of the robot body or limbs, the intended movement and operation of end effectors, and the intended paths orientations of such components. The command profile is roughly analogous to an automobile trip planned using a road map—constraints such as weather, traffic congestion, construction, or detours may prevent segments of the trip from being executed at the exact speed or along the exact route planned. In the case of the robot, because of the need to dynamically balance forces and moments while observing system constraints, the robot may not be able to execute the command profile exactly along the intended path, at the intended velocity or acceleration, at the intended time, in the intended body or peripheral orientation, or with the intended forces or moments on limbs and end effectors. The “system constraints” may include without limitation physical, dynamic, and policy constraints, and examples of such constraints include but are not limited to: limited foot pad adhesion; limited traction; limits on actuator capacity, travel, and rates; unactuated degrees of freedom; and policy limitations imposed by the user, such as a requirement that leg forces be applied in the vertical direction only or that acceleration be limited to avoid disturbing on-board equipment. The movement/force controller 100 provides optimized control instructions which: (a) cause the physical plant to execute the command profile in a manner that closely approximates the intended parameters (i.e., with acceptably small deviations from the intended parameters); (b) dynamically balance forces and moments on the robot including those applied by the robot to achieve propulsion or through use of an end-effector; and (c) comply with system constraints. System constraints may be defined in the control logic of the movement/force controller 100. Alternately, system constraints may be defined externally using any appropriate control or input device, and information describing the constraint may be supplied to the controller 100 using any appropriate signal path (not shown).

The term “balancing forces” is used herein to refer to controlling any forces and moments which the robot may impart to the environment, including without limitation those imparted by any of the robot's limbs on any supporting surfaces, and those imparted by any end effectors, such that the net forces and moments on the robot body, or on a coordinated system of limbs of the robot, closely approximate a set-point defining intended net forces and moments on the robot (or related coordinated system), such as those selected in the command profile. Non-quantitative references to “force” or “forces” are intended to also incorporate “moment” or “moments” unless otherwise specified or the context requires. When the forces imparted by the robot are controlled such that, in combination with the other external forces on the robot, they closely approximate a set-point defining intended net forces on the robot, the forces are said to be “balanced”. The movement/force controller 100 is often unable to issue control commands that would cause the robot to exactly conform to a set-point defining intended net forces on the robot, because such commands may cause the robot to exceed constraints of the type mentioned above. Accordingly, the movement/force controller 100 determines optimal commands that balance forces while minimizing error or difference between the intended value of a parameter and the control commands issued to control that parameter. “Closely approximate” is intended to mean that the error or difference between the intended value of a parameter and any commands issued by the controller to control that parameter is on the order of the error or difference produced using a least-squares error minimization method. Although a least-square error minimization method is described herein, one of skill in the art will appreciate that other error minimization methods could also be used.

Movement/force controller 100 further comprises elements 112, 114, 116, and 118, which function as follows. Element 112 is a state determining component, which determines the current state of the robot body and legs, which may include position and orientation, based on feedback from sensors 154 via path 158, and optionally, one or more prior state records. State information may also include measurements of external forces applied by or to the robot, including forces applied by or to the feet via adhesion or actuators, and forces applied by or to an end effector. Some of the state information may be determined by element 112 from current sensor measurements and may be passed to other components after no or minimal processing. External force measurements may be in this category. Other state information may be determined by the state determining element 112 in the form of one or more related derived parameters based on the sensor information or the determined positions or orientations. These “related derived parameters” may include without limitation rate-of-change information with respect to any parameter, and any other derivatives or integrals of those parameters. For example, “related derived parameters” may include linear or angular velocity or acceleration of the robot body or limbs. Element 112 furnishes the current state information, and optionally, one or more prior state records, via path 122 to element 114. Element 114 determines the current forces and moments acting on the robot 150, including the robot body and legs. Element 114 furnishes the current forces and moments to element 116 via path 124. Element 116 also receives the command profile established by element 110 via path 120. Element 116 determines the new optimized body forces and moments, and optionally other state parameters, required to achieve the command profile established by element 110, based on the forces and moments acting on the robot determined by element 114. The product of element 116 may be considered to be an “optimized state profile.” The optimized state profile is determined with respect to the body center-of-mass frame of reference. The optimized state profile is furnished to element 118 via path 126.

Element 118 determines for the ankle of each robot leg an optimized limb state command required to implement the optimized state profile determined by element 116. Each optimized limb state command may be a force command intended to be applied at the ankle of the corresponding leg. However, the optimized limb state command could also include other state parameters depending on the physical configuration of the robot limb and actuators thereof, and the ability of the conventional controllers 130 to provide control to achieve the commanded parameter. By way of example but not limitation, the optimized limb state command could include a moment parameter or a position displacement rate parameter in addition to, or instead of, force. Each optimized limb state command is determined with respect to the frame of reference of that limb. The optimized limb state commands are supplied to conventional controls 132, 134, 136, and 138 via path 128. For the particular robots 210 and 310 described herein, element 118 determines an optimized limb state command including a force parameter, but not a moment parameter, because as discussed further in connection with FIGS. 2-7, the particular robot described herein comprises ankle joints functionally equivalent to ball joints, lacking actuators, locks, or clutches. As a result, the ankle joints cannot be used directly to impart a moment on the foot. Of course, moments can be imparted on the surface to which the robot 150 is attached by applying differential forces on the legs. If a different robot leg configuration were used, permitting moments to be imparted to the foot, element 118 could determine both a force parameter and a moment parameter.

Elements 110, 112, 114, 116, and 118, thus, in combination, form a control logic implementation component which executes the logic, algorithms, methods, behavior, and the like described herein in connection with the controller 100. Although elements 110, 112, 114, 116, and 118 are depicted in FIG. 1 as separate blocks, in a physical embodiment of the movement/force controller 100, these elements may be integrated into a single apparatus or factored into any suitable combination of apparatus, consistent with the equipment available for implementing the controller. In some embodiments, the movement/force controller 100 may be implemented using known microcontroller or microprocessor equipment running appropriate control software to implement the control logic, algorithms, methods, behavior and the like described herein. Also, in some embodiments, the movement/force controller 100 may be implemented as part of a general purpose control system for the robot; in other embodiments, the movement/force controller 100 may be implemented as a dedicated controller separate from other control systems. In still other embodiments, the movement/force controller 100 may be implemented using special-purpose control hardware. The controller 100 preferably has appropriate Input/Output or peripheral facilities to enable receipt of sensor information 154, and to enable output, delivery, or transmission of force commands to conventional controls 130.

According to a further aspect of the present invention, in order to determine the optimal limb state commands for each leg, movement/force controller 100 preferably distributes the asymmetrical loading on the robot to its multiple redundant legs using mass impedance in a dynamic state with least-square error minimization to maintain positive adhesion at its food pads. Although a least-square error minimization method is described herein, one of skill in the art will appreciate that other error minimization methods could also be used. Because the robot includes multiple legs and may be subject to a plurality of external forces, the least-square solution for certain combinations of parameters to be controlled and certain numbers of forces may be indeterminate. To avoid indeterminate least-square solutions, the movement/force controller 100 decomposes the robot system into a number of individual force determination problems, each involving a different, non-redundant subset of forces. Eliminating the redundancy renders the individual problems determinate, and therefore least-square solutions to these problems can be obtained. The movement/force controller 100 then combines the results of the individual problems using superposition, to produce a solution that globally balances all of the external forces and moments acting on the robot, including all legs and, where appropriate, forces and moments arising from the use of any end-effector tools, and other external moments and forces. Each force determination is validated against system constraints, such as the maximum force which may be output by actuators, and the limits on footpad adhesion, and is normalized or adjusted as necessary.

The following discussion explains in more detail how movement/force controller 100 determines the forces to be applied to the legs of the robot in several example configurations and for several types of movement profile. The following definitions of some common variables are provided to give the reader a key to interpreting the subscripts, superscripts, and other nomenclature of similar variables:
m=total mass of AWIMR
I^{cm}=AWIMR inertia tensor about center of mass frame
r=body radius of AWIMR
h=body height of AWIMR
F̅_{cm}^{W}=total force acting on center of mass in world frame
ā_{cm}^{W}=acceleration of center of mass in world frame
F̅ᵢ^{W}=ground force acting on ankle joint of i^{th} leg in world frame
r̅_{i/cm}^{W}=position of ankle joint of i^{th} leg with respect to center of mass in world frame
M̅_{cm}^{W}=total moment acting on center of mass in world frame
R_{i/cm}^{W}=moment arm cross product matrix
α̅_{cm/W}^{W}=angular acceleration of center of mass frame with respect to world frame in world frame
ω̅_{cm/W}^{W}=angular velocity of center of mass frame with respect to world frame in world frame
C_{cm}^{W}=DCM transformation from center of mass frame to world frame

FIG. 4 further depicts the “ground” forces (i.e., forces with respect to the base or supporting surface) applied to a 6-legged robot 210 walking in a symmetrical tripod gait. Feet 1, 3, and 5 (legs 220, 216, and 224, respectively) are being pulled-off while feet 2, 4, and 6 (legs 218, 214, and 222, respectively) are equally preloaded. This parallel application of ground forces yields zero net forces and moments at the robot center of mass, as shown in the following equations:

$${\vec{F}}_{cm}^{W} = \sum {\vec{F}}_{i}^{W} = 0$$

$${\vec{M}}_{cm}^{W} = \sum {\vec{r}}_{i / cm}^{W} \times {\vec{F}}_{i}^{W} = 0$$

These conditions allow the robot to walk in low-, micro-, or zero-gravity environments with a position controller without risk of unbalanced dynamics that may cause the position controller to apply too much pull on a foot to cause loss of adhesion.

Kinematically, the tripod gait is efficient because it takes only three beats to complete a gait cycle. The robot can detach a tripod of legs from the surface, move the body and tripod forward, and then preload the tripod. However, the tripod gait requires all six legs to walk. Thus, it may not be possible to provide an end-effector for environmental manipulation. In addition, the tripod gait is too risky for walking on uneven surfaces or climbing onto angled surfaces as the position controller may apply too much pull-off force on a foot pad due to asymmetrical loading dynamics. Thus, although a conventional position controller could be used to control a six-legged robot executing a symmetrical tripod gait, the inventive movement/force controller 100 operating as described below may still provide advantages in controlling movement over irregular or angled surfaces. It should be noted that the robot 210 cannot directly apply any moments at its ankle joints, because the ankle joints are ball joints or their functional equivalents.

FIG. 5 shows the ground forces applied to a 6-legged robot walking in a symmetrical pairwise gait. Feet 1 and 4 (legs 220 and 214, respectively) are being pulled off from the surface or base, while feet 2, 3, 5, and 6 (legs 216, 218, 222, and 224, respectively) are equally preloaded at half the force. This parallel application of ground forces also yields zero net forces and moments at the AWIMR center of mass, as shown in the equations below:

$${\vec{F}}_{cm}^{W} = \sum {\vec{F}}_{i}^{W} = 0$$

$${\vec{M}}_{cm}^{W} = \sum {\vec{r}}_{i / cm}^{W} \times {\vec{F}}_{i}^{W} = 0$$

These conditions again allow the robot to walk in low-, micro-, or zero-gravity environments with a position controller without risk of unbalanced dynamics that may cause the position controller to apply too much pull on a foot to cause loss of adhesion.

Kinematically, the pairwise gait is not as efficient as the tripod gait. It takes twice the number of beats to complete a gait cycle as the robot is only moving two legs at a time, thus requiring it to move independently at least two pairs of legs to regain an even six legged stance. However, the pairwise gait is a little safer (but still risky) than the tripod gait when negotiating asymmetrical loading because it has 4 legs stuck to the ground during its walk. Thus if a conventional position controller for the legs overreacts and accidentally pulls off one of the legs, it still has three remaining legs to provide attachment to the base surface. However, it is still risky to operate the robot under asymmetrical walking conditions when controlled by a conventional position controller. Thus, the inventive movement/force controller 100 operating as described below may still provide advantages, including improved stability, in controlling movement under asymmetrical conditions. This gait also prevents the installation of an end-effector as all six legs are required for ambulation.

An asymmetrical gait results in asymmetrical forces applied to the legs. FIG. 6 shows a four-legged robot 310 trying to pull off the foot of leg 318. To maintain traction safety, the controller will try to maintain anchor on the other three feet. However, unlike the pairwise gait shown in FIG. 5, the controller cannot apply the same amount of ground force at the foot of opposing leg 324 to cancel out the pull-off force on the foot of leg 318 without risking detachment. As a result, the asymmetrical forces leave residual dynamics at the body (see the center of mass frame). These conditions are described by the following equations:

$${\vec{F}}_{cm}^{W} = \sum {\vec{F}}_{i}^{W} = {ɛ}_{F} \neq 0$$

$${\vec{M}}_{cm}^{W} = \sum {\vec{r}}_{i / cm}^{W} \times {\vec{F}}_{i}^{W} = {ɛ}_{M} \neq 0$$

A conventional position controller in this situation will increase the force at the foot of opposing leg 324 to counteract the body dynamics to maintain position and orientation. The symmetry of the legs shown in FIG. 6 would cause the position controller to apply at least the same amount of force on the foot of opposing leg 324 as on the foot of leg 318, and thus cause the force on leg 324 to exceed the adhesive strength and be pulled free.

In order to prevent Foot 3 from being detached, an embodiment of a movement/force controller 100 constructed in accordance with an aspect the present invention controls for dynamic stability instead of the static stability which is the object of a conventional position controller. The capability of dynamic stability provides safe operation of the robot when walking using an asymmetric gait, and will also balance asymmetric forces for proper operation when the robot uses its end-effector 350 to apply work on the environment.

FIG. 7 depicts a four-legged (quadrupedal) robot 310 with random asymmetrical forces at its feet, resulting in dynamic body motion as shown in the equations below:

$${\vec{F}}_{cm}^{W} = \sum {\vec{F}}_{i}^{W} = {ɛ}_{F} \neq 0$$

$${\vec{M}}_{cm}^{W} = \sum {\vec{r}}_{i / cm}^{W} \times {\vec{F}}_{i}^{W} = {ɛ}_{M} \neq 0$$

The equations of motion for this instance are derived below. The robot cannot apply any moments at its ankle joints because the ankles are ball joints or their functional equivalents.

Equation A shows the inertia tensor of the robot 310:

$$\begin{matrix}{I}^{cm} = [ \begin{matrix}{I}_{xx}^{cm} & {I}_{xy}^{cm} & {I}_{xz}^{cm} \\ {I}_{yx}^{cm} & {I}_{yy}^{cm} & {I}_{yz}^{cm} \\ {I}_{zx}^{cm} & {I}_{zy}^{cm} & {I}_{zz}^{cm}\end{matrix} ] \\ = [ \begin{matrix}{mr}^{2} / 4 + {mh}^{2} 12 & 0 & 0 \\ 0 & {mr}^{2} / 4 + {mh}^{2} / 12 & 0 \\ 0 & 0 & {mr}^{2} / 2\end{matrix} ] ⇒ \\ for a cyclinder\end{matrix}$$

The robot is approximated as a cylinder of constant density. All of the forces applied at the ankle from the ground will be accounted for in the ground's frame (also known as the “World Frame” or W). The body frame is denoted by ‘CM’ and it sits at the center of mass. For example, Equation B shows how to sum the forces from the legs (denoted by the i-th leg) in the world frame.

$${\vec{F}}_{cm}^{W} = \sum {\vec{F}}_{i}^{W} = m {\overline{a}}_{cm}^{W}$$

The position of the CM in the world frame can be accounted for by integrating.

Equation C shows the rigid body dynamics assumption:

$$\begin{matrix}{\overline{M}}_{cm}^{W} = \sum ( {\vec{r}}_{i / cm}^{W} \times {\vec{F}}_{i}^{W} ) \\ = \sum ( {R}_{i / cm}^{W} {\vec{F}}_{i}^{W} ) \\ = {C}_{cm}^{W} ( {I}^{cm} {\vec{α}}_{cm / W}^{cm} + skew ( {\vec{ω}}_{cm / W}^{cm} ) {I}^{cm} {\vec{ω}}_{cm / W}^{cm} )\end{matrix}$$

The moments are computed in the world frame but the rotational rates are accounted for and integrated in the body frame (or CM frame). The rotational position is integrated and accounted for in a DCM. The skew symmetric matrix function is shown in Equation D:

$$skew ( {\vec{ω}}_{cm / W}^{cm} ) = [ \begin{matrix}0 & - {ω}_{z} & {ω}_{y} \\ {ω}_{z} & 0 & - {ω}_{x} \\ - {ω}_{y} & {ω}_{x} & 0\end{matrix} ]$$

The skew symmetric cross product matrix is defined in Equation E:

R_{i/cm}^{W}=skew( r̅_{i/cm}^{W})

and applied in Equation C.

This analysis assumes a perfect feedback force controller that is to be applied at each individual leg responsive to commands generated as discussed below. This analysis also assumes rigid body dynamics and zero sensor error.

The behavior of movement/force controller 100 is described in the following subsections corresponding to the solutions obtained when particular situations are encountered. By combining the solutions described in various subsections, a complete asymmetrical gait can be executed. One of skill in the art will appreciate that the same methodology may be used to control the robot in the case of general asymmetrical loading, such as that created when the end-effector is used.

Least Square Distribution of CM Forces and Moments on One, Two, and Three Legs

The state equation of the least square function is shown in Equation F:

(A x̅− b̅= ε̅) [symbol] select optimal x̅ to minimize ( ε̅^{T} ε̅)

The object of a least square function is to minimize the square of the error between the state vector ‘x’ and the measurement vector ‘b’ by finding the optimal vector ‘x’ that will minimize ε^{T}ε. However, the optimal vector ‘x’ can be found only if the system is determinate, as shown in Equation G:

x̅ₒₚₜ=(A^{T}A)⁻¹A^{T} b̅→if det(A^{T}A)≠0

The problem with using the least square method to distributing the forces at the legs of the robot is redundancy. The conventional approach might be to attempt to control six parameters: the three forces and the three moments acting on the body. However, all six parameters can actually be affected using only the three directions of forces applied at the ankle. The ankle forces can not only transmit forces directly to the robot body but can also transmit moments via the moment arm of the leg. Thus, if the robot has more than one leg, a least-square solution cannot be derived by including either all the forces at the legs as states or all the forces and moments at the center of mass as controlled parameters, because the inherent redundancy would result in an indeterminate system.

Equation H shows a least square solution to the desired forces and moments at center of mass with all three forces at a single leg:

$$A = \underbrace{[ \begin{matrix}{I}_{3 \times 3} \\ ⋯ \\ {R}_{i / cm}^{W}\end{matrix} ]}_{6 \times 3} , \vec{x} = \underbrace{{\vec{F}}_{i}^{W}}_{3 \times 1} , \vec{b} = \underbrace{[ \begin{matrix}{\vec{F}}_{cm}^{W} \\ ⋯ \\ {\vec{M}}_{cm}^{W}\end{matrix} ]}_{6 \times 1}$$

When two legs are present, the controlled parameters must be carefully selected. Since primary forces at the ankles that are required for walking are in the vertical direction (pull-off and preload), the Z-direction CM force and the X and Y-direction CM moments are selected as the controlled parameters. The vertical forces at the ankles as selected as the only states for the situations involving two legs and three legs. The two-leg situation is shown in Equation I:

$$A = \underbrace{[ \begin{matrix}1 & 1 \\ {R}_{1 / c m}^{W} ( 1 , 3 ) & {R}_{2 / c m}^{W} ( 1 , 3 ) \\ {R}_{1 / c m}^{W} ( 2 , 3 ) & {R}_{2 / c m}^{W} ( 2 , 3 )\end{matrix} ]}_{3 \times 2} , \\ \vec{x} = \underbrace{[ \begin{matrix}{\vec{F}}_{1}^{W} ( 3 , 1 ) \\ {\vec{F}}_{2}^{W} ( 3 , 1 )\end{matrix} ]}_{2 \times 1} , \\ \vec{b} = \underbrace{[ \begin{matrix}{\vec{F}}_{c m}^{W} ( 3 , 1 ) \\ {\vec{M}}_{c m}^{W} ( 1 , 1 ) \\ {\vec{M}}_{c m}^{W} ( 2 , 1 )\end{matrix} ]}_{3 \times 1}$$

$${\vec{x}}_{opt} = {( {A}^{T} A )}^{- 1} {A}^{T} \vec{b}$$

The three-leg situation is shown if Equation J:

$$A = \underbrace{[ \begin{matrix}1 & 1 & 1 \\ {R}_{1 / c m}^{W} ( 1 , 3 ) & {R}_{2 / c m}^{W} ( 1 , 3 ) & {R}_{3 / c m}^{W} ( 1 , 3 ) \\ {R}_{1 / c m}^{W} ( 2 , 3 ) & {R}_{2 / c m}^{W} ( 2 , 3 ) & {R}_{3 / c m}^{W} ( 2 , 3 )\end{matrix} ]}_{3 \times 3} , \\ \vec{x} = \underbrace{[ \begin{matrix}{\vec{F}}_{1}^{W} ( 3 , 1 ) \\ {\vec{F}}_{2}^{W} ( 3 , 1 ) \\ {\vec{F}}_{3}^{W} ( 3 , 1 )\end{matrix} ]}_{3 \times 1} , \\ \vec{b} = \underbrace{[ \begin{matrix}{\vec{F}}_{c m}^{W} ( 3 , 1 ) \\ {\vec{M}}_{c m}^{W} ( 1 , 1 ) \\ {\vec{M}}_{c m}^{W} ( 2 , 1 )\end{matrix} ]}_{3 \times 1}$$

$${\vec{x}}_{opt} = {( {A}^{T} A )}^{- 1} {A}^{T} \vec{b}$$

Solution A: Balancing Leg Lift with Three Legs Planted

In the situation where a single leg is lifted, the forces cannot be statically counterbalanced without risking the accidental pull-off of the opposing leg, especially when the robot is in a symmetric stance. Equation K shows how to dynamically balance the asymmetric leg pull-off forces in a least square sense.

$$\begin{matrix}{\vec{F}}_{1}^{W} = ground force on leg being pulled off \\ = {[ \begin{matrix}0 & 0 & {\vec{F}}_{1}^{W} ( 3 , 1 )\end{matrix} ]}^{T}\end{matrix}$$

$${\vec{M}}_{c m 1}^{W} = {R}_{1 / c m}^{W} {\vec{F}}_{1}^{W}$$

$$A = {\underbrace{[ \begin{matrix}{R}_{3 / c m}^{W} ( 1 , 3 ) \\ {R}_{3 / c m}^{W} ( 2 , 3 )\end{matrix} ]}}_{2 \times 1} , \\ \vec{x} = \underbrace{[ {\vec{F}}_{3}^{W} ( 3 , 1 ) ]}_{1 \times 1} , \\ \vec{b} = {\underbrace{[ \begin{matrix}- {\vec{M}}_{c m 1}^{W} ( 1 , 1 ) \\ - {\vec{M}}_{c m 1}^{W} ( 2 , 1 )\end{matrix} ]}}_{2 \times 1}$$

$${\vec{x}}_{opt} = {( {A}^{T} A )}^{- 1} {A}^{T} \vec{b}$$

$${\vec{F}}_{3}^{W} = ground force on opposing leg = {[ \begin{matrix}0 & 0 & {\vec{x}}_{opt} ( 1 , 1 )\end{matrix} ]}^{T}$$

$$\begin{matrix}if ( {\vec{F}}_{3}^{W} > 0.5 * leg\_pull \_off \_force ) ⇒ \\ {\vec{F}}_{3}^{W} = 0.5 * leg\_pull \_off \_force\end{matrix}$$

Balancing the asymmetric forces will result in residual body dynamics—that is, movement.

For analysis purposes, assume that leg 318 is the desired leg to be lifted or pulled free. The first step is to find the ground force on the opposing leg 324 to counterbalance the force on leg 318. Equation K uses the single leg least square method shown in Equation H to find the least square force on the opposing leg 324. It is then necessary to determine whether the force on opposing leg 324 would exceed the defined adhesion force limit. If so, there is a risk that leg 324 would undesirably detach from the surface. If the calculated force on leg 324 exceeds the adhesion limit, the force reset to that limit to avoid unintentional detachment of the leg 324.

The forces and moments at the body resulting from legs 318 and 324 are summed as shown in Equation L:

$${\vec{F}}_{2}^{W} = {[ \begin{matrix}0 & 0 & 0\end{matrix} ]}^{T}$$

$${\vec{F}}_{4}^{W} = {[ \begin{matrix}0 & 0 & 0\end{matrix} ]}^{T}$$

$${\vec{F}}_{c m}^{W} = \sum {\vec{F}}_{i}^{W} , \\ {\vec{M}}_{c m}^{W} = \sum {R}_{i / c m}^{W} {\vec{F}}_{i}^{W}$$

Then, using the least square method for two legs as shown in Equation I, the ground forces at legs 316 and 322 are applied in an attempt to zero out the forces and moments at the body. The least square method is shown in Equation M:

$$A = \underbrace{[ \begin{matrix}1 & 1 \\ {R}_{2 / c m}^{W} ( 1 , 3 ) & {R}_{4 / c m}^{W} ( 1 , 3 ) \\ {R}_{2 / c m}^{W} ( 2 , 3 ) & {R}_{4 / c m}^{W} ( 2 , 3 )\end{matrix} ]}_{3 \times 2} , \\ \vec{x} = \underbrace{[ \begin{matrix}{\vec{F}}_{2}^{W} ( 3 , 1 ) \\ {\vec{F}}_{4}^{W} ( 3 , 1 )\end{matrix} ]}_{2 \times 1} , \\ \vec{b} = \underbrace{[ \begin{matrix}- {\vec{F}}_{c m}^{W} ( 3 , 1 ) \\ - {\vec{M}}_{c m}^{W} ( 1 , 1 ) \\ - {\vec{M}}_{c m}^{W} ( 2 , 1 )\end{matrix} ]}_{3 \times 1}$$

$${\vec{x}}_{opt} = {( {A}^{T} A )}^{- 1} {A}^{T} \vec{b}$$

$${\vec{F}}_{2}^{W} = {[ \begin{matrix}0 & 0 & {\vec{x}}_{opt} ( 2 , 1 )\end{matrix} ]}^{T} , \\ {\vec{F}}_{4}^{W} = {[ \begin{matrix}0 & 0 & {\vec{x}}_{opt} ( 2 , 2 )\end{matrix} ]}^{T}$$

$${\vec{F}}_{c m}^{W} = \sum {\vec{F}}_{i}^{W} = {ɛ}_{F} , \\ {\vec{M}}_{c m}^{W} = \sum {R}_{i / c m}^{W} {\vec{F}}_{i}^{W} = {ɛ}_{M} ⇒ Propagate AWIMR Dynamics$$

The residual body forces and moments result in dynamic movement of the robot body. The least square force control method iterates until the foot is detached and the leg lift operation is completed. Although the residual body forces and moments are used to dynamically control the movement of the robot body, the body will likely still be moving at the end of this operation. In order to stop this motion, it is necessary to apply SOLUTION D (discussed below) iteratively, until the external forces and moments have been balanced and movement of the robot body ceases or is reduced to an acceptably small amount.

Solution B: Balancing Leg Preload with Three Legs Planted

Balancing the forces when a single leg is preloaded is almost identical to balancing the forces when a single leg is lifted, as described in the Solution A section. The only difference is that is it not necessary to limit the maximum counter preload force at the opposing leg because of the sign of the force. As before, for analysis purposes, assume that leg 318 is the leg to be preloaded or pushed into ground or supporting surface. Equations N through P are nearly identical to Equation K through M. However, it is not necessary to check that the count-preload force exceeds the maximum adhesion limit at the end of Equation N.

Equation N shows how to balance the asymmetric leg preload forces in a least square sense:

$${\vec{F}}_{1}^{W} = ground force on leg being preloaded = {[ \begin{matrix}0 & 0 & {\vec{F}}_{1}^{W} ( 3 , 1 )\end{matrix} ]}^{T}$$

$${\vec{M}}_{c m 1}^{W} = {R}_{1 / c m}^{W} {\vec{F}}_{1}^{W}$$

$$A = \underbrace{[ \begin{matrix}{R}_{3 / c m}^{W} ( 1 , 3 ) \\ {R}_{3 / c m}^{W} ( 2 , 3 )\end{matrix} ]}_{2 \times 1} , \\ \vec{x} = \underbrace{[ {\vec{F}}_{3}^{W} ( 3 , 1 ) ]}_{1 \times 1} , \\ \vec{b} = \underbrace{[ \begin{matrix}- {\vec{M}}_{c m 1}^{W} ( 1 , 1 ) \\ - {\vec{M}}_{c m 1}^{W} ( 2 , 1 )\end{matrix} ]}_{2 \times 1}$$

$${\vec{x}}_{opt} = {( {A}^{T} A )}^{- 1} {A}^{T} \vec{b}$$

$${\vec{F}}_{3}^{W} = ground force on opposing leg = {[ \begin{matrix}0 & 0 & {\vec{x}}_{opt} ( 1 , 1 )\end{matrix} ]}^{T}$$

The forces and moments at the body resulting from legs 318 and 324 are summed as shown in Equation O:

$${\vec{F}}_{2}^{W} = {[ \begin{matrix}0 & 0 & 0\end{matrix} ]}^{T}$$

$${\vec{F}}_{4}^{W} = {[ \begin{matrix}0 & 0 & 0\end{matrix} ]}^{T}$$

$${\vec{F}}_{c m}^{W} = \sum {\vec{F}}_{i}^{W} , \\ {\vec{M}}_{c m}^{W} = \sum {R}_{i / c m}^{W} {\vec{F}}_{i}^{W}$$

The ground forces at legs 316 and 322 are applied in an attempt to zero out the forces and moments at the body. The least square method is shown in Equation P:

$$A = \underbrace{[ \begin{matrix}1 & 1 \\ {R}_{2 / c m}^{W} ( 1 , 3 ) & {R}_{4 / c m}^{W} ( 1 , 3 ) \\ {R}_{2 / c m}^{W} ( 2 , 3 ) & {R}_{4 / c m}^{W} ( 2 , 3 )\end{matrix} ]}_{3 \times 2} , \\ \vec{x} = \underbrace{[ \begin{matrix}{\vec{F}}_{2}^{W} ( 3 , 1 ) \\ {\vec{F}}_{4}^{W} ( 3 , 1 )\end{matrix} ]}_{2 \times 1} , \\ \vec{b} = \underbrace{[ \begin{matrix}- {\vec{F}}_{c m}^{W} ( 3 , 1 ) \\ - {\vec{M}}_{c m}^{W} ( 1 , 1 ) \\ - {\vec{M}}_{c m}^{W} ( 2 , 1 )\end{matrix} ]}_{3 \times 1}$$

$${\vec{x}}_{opt} = {( {A}^{T} A )}^{- 1} {A}^{T} \vec{b}$$

$${\vec{F}}_{2}^{W} = {[ \begin{matrix}0 & 0 & {\vec{x}}_{opt} ( 2 , 1 )\end{matrix} ]}^{T} , \\ {\vec{F}}_{4}^{W} = {[ \begin{matrix}0 & 0 & {\vec{x}}_{opt} ( 2 , 2 )\end{matrix} ]}^{T}$$

$${\vec{F}}_{c m}^{W} = \sum {\vec{F}}_{i}^{W} = {ɛ}_{F} , \\ {\vec{M}}_{c m}^{W} = \sum {R}_{i / c m}^{W} {\vec{F}}_{i}^{W} = {ɛ}_{M} ⇒ Propagate AWIMR Dynamics$$

Solution C: Balancing Leg Swing with Three Legs Planted

For analysis, assume that leg 318 is swinging forward, and it is desired to counterbalance the reaction force on planted legs 316, 324, and 322. To balance the leg swing, it is necessary to first calculate the acceleration of the center of mass of leg 318. To facilitate analysis and to ensure that the worst-case scenario has been accounted for, assume that the entire leg mass is concentrated at the ankle.

The first step is to calculate the force from CM acceleration of leg 318, and split it into a z component and an x-y component. The z-component is then balanced using the 3-leg least square method as shown in Equation Q:

$${\vec{F}}_{1}^{W} = reaction force applied on leg c m during leg swing$$

$${\vec{F}}_{1}^{W} = {m}_{leg 1} {\vec{a}}_{leg 1}^{W} ⇒ {\vec{F}}_{1 xy}^{W} = [ \begin{matrix}{\vec{F}}_{1}^{W} ( 1 , 1 ) & {\vec{F}}_{1}^{W} ( 2 , 1 ) & 0\end{matrix} ] , \\ {\vec{F}}_{1 z}^{W} = [ \begin{matrix}0 & 0 & {\vec{F}}_{1}^{W} ( 3 , 1 )\end{matrix} ]$$

$${\vec{M}}_{c m 1}^{W} = {R}_{1 / c m}^{W} {\vec{F}}_{1}^{W}$$

$$A = \underbrace{[ \begin{matrix}1 & 1 & 1 \\ {R}_{2 / c m}^{W} ( 1 , 3 ) & {R}_{3 / c m}^{W} ( 1 , 3 ) & {R}_{4 / c m}^{W} ( 1 , 3 ) \\ {R}_{2 / c m}^{W} ( 2 , 3 ) & {R}_{3 / c m}^{W} ( 2 , 3 ) & {R}_{4 / c m}^{W} ( 2 , 3 )\end{matrix} ]}_{3 \times 3} , \\ \vec{x} = \underbrace{[ \begin{matrix}{\vec{F}}_{2}^{W} ( 3 , 1 ) \\ {\vec{F}}_{3}^{W} ( 3 , 1 ) \\ {\vec{F}}_{4}^{W} ( 3 , 1 )\end{matrix} ]}_{3 \times 1} , \\ \vec{b} = \underbrace{[ \begin{matrix}- {\vec{F}}_{1 z}^{W} ( 3 , 1 ) \\ - {\vec{M}}_{c m 1}^{W} ( 1 , 1 ) \\ - {\vec{M}}_{c m 1}^{W} ( 2 , 1 )\end{matrix} ]}_{3 \times 1}$$

$${\vec{x}}_{opt} = {( {A}^{T} A )}^{- 1} {A}^{T} \vec{b}$$

$${\vec{F}}_{2}^{W} = {[ \begin{matrix}0 & 0 & {\vec{x}}_{opt} ( 1 , 1 )\end{matrix} ]}^{T} , \\ {\vec{F}}_{4}^{W} = {[ \begin{matrix}0 & 0 & {\vec{x}}_{opt} ( 3 , 1 )\end{matrix} ]}^{T}$$

$${\vec{F}}_{3 z}^{W} = {[ \begin{matrix}0 & 0 & {\vec{x}}_{opt} ( 2 , 1 )\end{matrix} ]}^{T} ⇒ z component of opposing leg planted from the swinging leg$$

The x-y component is then balanced with respect to the opposing leg 324 using the 1-leg least square method as shown in Equation R:

$$A = [ \begin{matrix}{I}_{3 \times 3} \\ ⋯ \\ {R}_{3 / c m}^{W}\end{matrix} ] , \\ \vec{x} = {\underbrace{{\vec{F}}_{3 xy}^{W}}}_{3 \times 1} , \\ \vec{b} = \underbrace{[ \begin{matrix}- {\vec{F}}_{1 xy}^{W} \\ ⋯ \\ - {R}_{1 / c m}^{W} {\vec{F}}_{1 xy}^{W}\end{matrix} ]}_{6 \times 1}$$

$${\vec{x}}_{opt} = {( {A}^{T} A )}^{- 1} {A}^{T} \vec{b}$$

$${\vec{F}}_{3 xy}^{W} = {\vec{x}}_{opt}$$

$${\vec{F}}_{3}^{W} = {\vec{F}}_{3 z}^{W} + {\vec{F}}_{3 xy}^{W}$$

$${\vec{F}}_{c m}^{W} = \sum {\vec{F}}_{i}^{W} = {ɛ}_{F} , \\ {\vec{M}}_{c m}^{W} = \sum {R}_{i / c m}^{W} {\vec{F}}_{i}^{W} = {ɛ}_{M} ⇒ Propagate AWIMR Dynamics$$

The resulting ground forces to be applied to the three planted legs are superimposed and the residual forces and moments at the body CM are then used to dynamically control the movement of the robot body as shown in Equation R. The residual body forces and moments result in dynamic movement of the robot body. The least square force control method iterates until the foot is adhesively attached to the supporting surface and the leg preload operation is completed. Although the residual body forces and moments are used to dynamically control the movement of the robot body, the body will likely still be moving at the end of this operation. In order to stop this motion, it is necessary to apply SOLUTION D (discussed below) iteratively, until the external forces and moments have been balanced and movement of the robot body ceases or is reduced to an acceptably small amount.

Solution D: Shifting and Rotating Robot Body Mass with Three Legs Planted

This section describes how to distribute the required ground forces on three legs given the desired forces (3-axis) and moments (3-axis) to be applied at the robot body center of mass. For analysis, legs 316, 318, and 324 are selected as the legs to which the ground forces are distributed.

First, it is necessary to calculate the desired forces and moments at the body CM in the world frame, as shown in Equation S:

F̅_{cm}_{_{—}}_{desired}_{_{—}}_{cmd}^{W}=m α̅_{cm}_{_{—}}_{cmd}^{W}

M̅_{cm}_{_{—}}_{desired}_{_{—}}_{cmd}^{W}=C_{cm}^{W}(I^{cm} α̅_{cm/W}_{_{—}}_{cmd}^{cm}+skew( ω̅_{cm/W}^{cm})I^{cm} ω̅_{cm/W}^{cm})

The desired ground forces at the legs are always calculated in the world frame.

The desired forces are then allocated equally to the three legs, and the moment at the body center of mass caused by the three ground forces are subtracted from the original desired moment command. This is shown in Equation T:

F̅_{cm}_{_{—}}_{cmd}^{W}= F̅_{cm}_{_{—}}_{desired}_{_{—}}_{cmd}^{W}

F̅₁^{W}= F̅₂^{W}= F̅₃^{W}= F̅_{cm}_{₁₃}_{cmd}^{W}/3

M̅_{cm}_{_{—}}_{desired}_{_{—}}_{cmd}^{W}= M̅_{cm}_{_{—}}_{desired}_{_{—}}_{cmd}^{W}−R_{i/cm}^{W} F̅ᵢ^{W}

The three leg least square method is then applied with a desired CM force of zero to calculate additional z-components in the ground forces to achieve the desired body CM moments in the x and y directions, as shown in equation U:

$$A = \underbrace{[ \begin{matrix}1 & 1 & 1 \\ {R}_{1 / c m}^{W} ( 1 , 3 ) & {R}_{2 / c m}^{W} ( 1 , 3 ) & {R}_{3 / c m}^{W} ( 1 , 3 ) \\ {R}_{1 / c m}^{W} ( 2 , 3 ) & {R}_{2 / c m}^{W} ( 2 , 3 ) & {R}_{3 / c m}^{W} ( 2 , 3 )\end{matrix} ]}_{3 \times 3} , \\ \vec{x} = \underbrace{[ \begin{matrix}{\vec{F}}_{1 z}^{W} ( 3 , 1 ) \\ {\vec{F}}_{2 z}^{W} ( 3 , 1 ) \\ {\vec{F}}_{3 z}^{W} ( 3 , 1 )\end{matrix} ]}_{3 \times 1} , \\ \vec{b} = \underbrace{[ \begin{matrix}0 \\ {\vec{M}}_{cm\_desired \_cmd}^{W} ( 1 , 1 ) \\ {\vec{M}}_{cm\_desired \_cmd}^{W} ( 2 , 1 )\end{matrix} ]}_{3 \times 1}$$

$${\vec{x}}_{opt} = {( {A}^{T} A )}^{- 1} {A}^{T} \vec{b}$$

$${\vec{F}}_{1 z}^{W} = {[ \begin{matrix}0 & 0 & {\vec{x}}_{opt} ( 1 , 1 )\end{matrix} ]}^{T} , \\ {\vec{F}}_{2 z}^{W} = {[ \begin{matrix}0 & 0 & {\vec{x}}_{opt}\end{matrix} ( 2 , 1 ) ]}^{T} , \\ {\vec{F}}_{3 z}^{W} = {[ \begin{matrix}0 & 0 & {\vec{x}}_{opt} ( 3 , 1 )\end{matrix} ]}^{T}$$

Lastly, the forces are summed, and the resulting forces and moments at the body CM are calculated as shown. Because a least square method is being used, this will leave some residuals in the original desired forces and moment command as shown in Equation V:

$${\vec{F}}_{i\_cmd}^{W} = {\vec{F}}_{i}^{W} + {\vec{F}}_{iz}^{W}$$

$${\vec{F}}_{cm\_cmd}^{W} = \sum {\vec{F}}_{i\_cmd}^{W} , \\ {\vec{M}}_{cm\_cmd}^{W} = \sum {R}_{i / c m}^{W} {\vec{F}}_{i\_cmd}^{W} \\ ** \text{NOTE:}$$

$$\begin{matrix}Δ {\vec{F}}_{cm\_cmd}^{W} = {\vec{F}}_{cm\_desired \_cmd}^{W} - \vec{F} \\ = {ɛ}_{F} ⇒ least square match\end{matrix}$$

$$\begin{matrix}Δ {\vec{M}}_{cm\_cmd}^{W} = {\vec{M}}_{cm\_desired \_cmd}^{W} - \vec{M} \\ = {ɛ}_{M} ⇒ least square match\end{matrix}$$

$$least square error may be large if {\vec{M}}_{cm\_desired \_cmd}^{W} ( 3 , 1 ) \neq 0$$

In most cases, it is not needed to proceed further, because it is usually not necessary to execute a body movement about the z-axis. However, if there is a desired moment command in the Z-axis, it must be distributed to each leg, in turn, using the one-leg least square method as shown in Equation W:

$$if ( abs ( Δ {\vec{M}}_{cm\_cmd}^{W} ( 3 , 1 ) ) >> 0 )$$

$$A = \underbrace{[ \begin{matrix}{I}_{3 \times 3} \\ ⋯ \\ {R}_{i / c m}^{W}\end{matrix} ]}_{6 \times 3} , \\ \vec{x} = \underbrace{{\vec{F}}_{i\_residual \_cmd}^{W}}_{3 \times 1} , \\ \vec{b} = \underbrace{[ \begin{matrix}{0}_{5 \times 1} \\ ⋯ \\ Δ {\vec{M}}_{cm\_cmd}^{W} ( 3 , 1 )\end{matrix} ]}_{6 \times 1}$$

$${\vec{x}}_{opt} = {( {A}^{T} A )}^{- 1} {A}^{T} \vec{b}$$

$${\vec{F}}_{i\_residual \_cmd}^{W} = {\vec{x}}_{opt}$$

$${\vec{F}}_{i\_cmd}^{W} = {\vec{F}}_{i\_cmd}^{W} + {\vec{F}}_{i\_residual \_cmd}^{W}$$

$$\begin{matrix}if ( {\vec{F}}_{i\_cmd}^{W} > k * leg\_pull \_off \_force ) ⇒ \\ {\vec{F}}_{i\_cmd}^{W} = k * leg\_pull \_off \_force\end{matrix}$$

$$0 < k < 1 ⇒ safety factor so to maintain foot pad adhesion$$

This last process involves iterating between Equation V and Equation W for each of the legs, in turn.

Solution E: Shifting and Rotating Robot Body Mass with Four Legs Planted

This section describes how to distribute the required ground forces on four legs given the desired forces (3-axis) and moments (3-axis) to be applied at the body center of mass. It is nearly identical to the previous Solution D. The only difference is that the required body moments are divided into halves and distributed equally to two sets of three legs, i.e., first, the tripod consisting of legs 318, 316, and 324, and next, the tripod consisting legs 318, 316, and 322. The resulting forces are then superimposed. This allows a least-square solution to be achieved for a four-leg system, wherein leg redundancy would render the least-square problem indeterminate. Decomposing the problem into two sub-problems of three legs each eliminates the leg redundancy for each sub-problem and renders the least-square solution for each sub-problem determinate.

$$\begin{matrix}\text{Equation X:} & \\ {\vec{F}}_{cm\_desired \_cmd}^{W} = m {\vec{a}}_{cm\_cmd}^{W} \\ {\vec{M}}_{cm\_desired \_cmd}^{W} = {C}_{c m}^{W} ( {I}^{c m} {\vec{α}}_{c m / W\_cmd}^{c m} + skew ( {\vec{ω}}_{c m / W}^{c m} ) {I}^{c m} {\vec{ω}}_{c m / W}^{c m} ) & \\ \text{Equation Y:} & \\ {\vec{F}}_{cm\_cmd}^{W} = {\vec{F}}_{cm\_desired \_cmd}^{W} \\ {\vec{F}}_{1}^{W} = {\vec{F}}_{2}^{W} = {\vec{F}}_{3}^{W} = {\vec{F}}_{4}^{W} = {\vec{F}}_{cm\_cmd}^{W} / 4 \\ {\vec{M}}_{cm\_desired \_cmd}^{W} = {\vec{M}}_{cm\_desired \_cmd}^{W} - {R}_{i / c m}^{W} {\vec{F}}_{i}^{W} & \\ \text{Equation Z:} & \\ A = \underbrace{[ \begin{matrix}1 & 1 & 1 \\ {R}_{1 / c m}^{W} ( 1 , 3 ) & {R}_{2 / c m}^{W} ( 1 , 3 ) & {R}_{3 / c m}^{W} ( 1 , 3 ) \\ {R}_{1 / c m}^{W} ( 2 , 3 ) & {R}_{2 / c m}^{W} ( 2 , 3 ) & {R}_{3 / c m}^{W} ( 2 , 3 )\end{matrix} ]}_{3 \times 3} , \\ \vec{x} = \underbrace{[ \begin{matrix}{\vec{F}}_{1 z 1}^{W} ( 3 , 1 ) \\ {\vec{F}}_{2 z 1}^{W} ( 3 , 1 ) \\ {\vec{F}}_{3 z}^{W} ( 3 , 1 )\end{matrix} ]}_{3 \times 1} , \\ \vec{b} = \underbrace{[ \begin{matrix}0 \\ {\vec{M}}_{cm\_desired \_cmd}^{W} ( 1 , 1 ) / 2 \\ {\vec{M}}_{cm\_desired \_cmd}^{W} ( 2 , 1 ) / 2\end{matrix} ]}_{3 \times 1} \\ {\vec{x}}_{opt} = {( {A}^{T} A )}^{- 1} {A}^{T} \vec{b} \\ {\vec{F}}_{1 z 1}^{W} = {[ \begin{matrix}0 & 0 & {\vec{x}}_{opt} ( 1 , 1 )\end{matrix} ]}^{T} , \\ {\vec{F}}_{2 z 1}^{W} = {[ \begin{matrix}0 & 0 & {\vec{x}}_{opt}\end{matrix} ( 2 , 1 ) ]}^{T} , \\ {\vec{F}}_{3 z}^{W} = {[ \begin{matrix}0 & 0 & {\vec{x}}_{opt} ( 3 , 1 )\end{matrix} ]}^{T} & \\ \text{Equation AA:} & \\ A = \underbrace{[ \begin{matrix}1 & 1 & 1 \\ {R}_{1 / c m}^{W} ( 1 , 3 ) & {R}_{2 / c m}^{W} ( 1 , 3 ) & {R}_{4 / c m}^{W} ( 1 , 3 ) \\ {R}_{1 / c m}^{W} ( 2 , 3 ) & {R}_{2 / c m}^{W} ( 2 , 3 ) & {R}_{4 / c m}^{W} ( 2 , 3 )\end{matrix} ]}_{3 \times 3} , \\ \vec{x} = \underbrace{[ \begin{matrix}{\vec{F}}_{1 z 2}^{W} ( 3 , 1 ) \\ {\vec{F}}_{2 z 2}^{W} ( 3 , 1 ) \\ {\vec{F}}_{4 z}^{W} ( 3 , 1 )\end{matrix} ]}_{3 \times 1} , \\ \vec{b} = \underbrace{[ \begin{matrix}0 \\ {\vec{M}}_{cm\_desired \_cmd}^{W} ( 1 , 1 ) / 2 \\ {\vec{M}}_{cm\_desired \_cmd}^{W} ( 2 , 1 ) / 2\end{matrix} ]}_{3 \times 1} \\ {\vec{x}}_{opt} = {( {A}^{T} A )}^{- 1} {A}^{T} \vec{b} \\ {\vec{F}}_{1 z 2}^{W} = {[ \begin{matrix}0 & 0 & {\vec{x}}_{opt} ( 1 , 1 )\end{matrix} ]}^{T} , \\ {\vec{F}}_{2 z 2}^{W} = {[ \begin{matrix}0 & 0 & {\vec{x}}_{opt}\end{matrix} ( 2 , 1 ) ]}^{T} , \\ {\vec{F}}_{4 z}^{W} = {[ \begin{matrix}0 & 0 & {\vec{x}}_{opt} ( 3 , 1 )\end{matrix} ]}^{T} & \\ \text{Equation BB:} & \\ {\vec{F}}_{1 z}^{W} = {\vec{F}}_{1 z 1}^{W} + {\vec{F}}_{1 z 2}^{W} \\ {\vec{F}}_{2 z}^{W} = {\vec{F}}_{2 z 1}^{W} + {\vec{F}}_{2 z 2}^{W} & \\ \text{Equation CC:} & \\ {\vec{F}}_{i\_cmd}^{W} = {\vec{F}}_{i}^{W} + {\vec{F}}_{i z}^{W} \\ {\vec{F}}_{cm\_cmd}^{W} = \sum {\vec{F}}_{i\_cmd}^{W} , \\ {\vec{M}}_{cm\_cmd}^{W} = \sum {R}_{i / c m}^{W} {\vec{F}}_{i\_cmd}^{W} \\ ** \text{NOTE:} \\ \begin{matrix}Δ {\vec{F}}_{cm\_cmd}^{W} = {\vec{F}}_{cm\_desired \_cmd}^{W} - {\vec{F}}_{cm\_cmd}^{W} \\ = {ɛ}_{F} ⇒ least square match\end{matrix} \\ \begin{matrix}Δ {\vec{M}}_{cm\_cmd}^{W} = {\vec{M}}_{cm\_desired \_cmd}^{W} - {\vec{M}}_{cm\_cmd}^{W} \\ = {ɛ}_{M} ⇒ least square match\end{matrix} \\ least square error may be large if {\vec{M}}_{cm\_desired \_cmd}^{W} ( 3 , 1 ) \neq 0 & \\ \text{Equation DD:} & \\ if ( abs ( Δ {\vec{M}}_{cm\_cmd}^{W} ( 3 , 1 ) ) >> 0 ) \\ A = \underbrace{[ \begin{matrix}{I}_{3 \times 3} \\ ⋯ \\ {R}_{i / c m}^{W}\end{matrix} ]}_{6 \times 3} , \\ \vec{x} = \underbrace{{\vec{F}}_{i\_residual \_cmd}^{W}}_{3 \times 1} , \\ \vec{b} = \underbrace{[ \begin{matrix}{0}_{5 \times 1} \\ ⋯ \\ Δ {\vec{M}}_{cm\_cmd}^{W} ( 3 , 1 )\end{matrix} ]}_{6 \times 1} \\ {\vec{x}}_{opt} = {( {A}^{T} A )}^{- 1} {A}^{T} \vec{b} \\ {\vec{F}}_{i\_residual \_cmd}^{W} = {\vec{x}}_{opt} \\ {\vec{F}}_{i\_cmd}^{W} = {\vec{F}}_{i\_cmd}^{W} + {\vec{F}}_{i\_residual \_cmd}^{W} \\ \begin{matrix}if ( {\vec{F}}_{i\_cmd}^{W} > k * leg\_pull \_off \_force ) ⇒ \\ {\vec{F}}_{i\_cmd}^{W} = k * leg\_pull \_off \_force\end{matrix} \\ 0 < k < 1 ⇒ safety factor so to maintain foot pad adhesion & \end{matrix}$$

Solution F: Generating a Command Profile to Stop Body Motion

As shown in the previous section describing Solution E, counterbalancing asymmetric gait forces such as a leg pull-off force will result in residual forces and moments at the body CM that will result in dynamic motion. Therefore, it is necessary to generate a command profile to bring the motion to a stop in a manner compliant with footpad adhesion and other constraints. FIG. 8 depicts a typical jerk-limited acceleration profile 810 that will bring a non-zero initial velocity to a zero final velocity condition. In order to bring the body motion to a stop the acceleration command is profiled in the world frame and the angular acceleration command is profiled in the body frame. This is shown in Equation EE:

for (time ≦tⱼ)

ā_{cm}_{_{—}}_{cmd}^{W}=(− v̅_{cm}_{_{—}}_{cmd}_{_{—}}ᵢₙᵢₜᵢₐₗ^{w}/(tₐ+tⱼ)tⱼ)*time

α̅_{cm/W}_{_{—}}_{cmd}^{cm}=(− ω̅_{cm/W}_{_{—}}ᵢₙᵢₜᵢₐₗ^{cm}/(tₐ+tⱼ) tⱼ)*time

for (tⱼ≦time≦tₐ+tⱼ)

ā_{cm}_{_{—}}_{cmd}^{W}=− v̅_{cm}_{_{—}}_{cmd}_{_{—}}ᵢₙᵢₜᵢₐₗ^{W}/(tₐ+tⱼ)

α̅_{cm/W}_{₁₃} _{cmd}^{cm}= ω̅_{cm/W}_{_{—}}ᵢₙᵢₜᵢₐₗ^{cm}/(tₐ+tⱼ)

for (tₐ+tⱼ≦time≦tₐ+2tⱼ)

ā_{cm}_{_{—}}_{cmd}^{W}=− v̅_{cm}_{_{—}}_{cmd}_{_{—}}ᵢₙᵢₜᵢₐₗ^{W}/(tₐ+tⱼ)+( v̅_{cm}_{_{—}}_{cmd}_{_{—}}ᵢₙᵢₜᵢₐₗ^{W}/(tₐ+tⱼ)tⱼ)*(time−tₐ+tⱼ))

α̅_{cm/W}_{_{—}}_{cmd}^{cm}=− v̅_{cm}_{_{—}}_{cmd}_{_{—}}ᵢₙᵢₜᵢₐₗ^{W}/(tₐ+tⱼ)+( ω̅_{cm/W}_{_{—}}ᵢₙᵢₜᵢₐₗ^{cm}/(tₐ+tⱼ)tⱼ)*(time−(tₐ+tⱼ))

Solution G: Generating a Command Profile to Position and Orient the Body

Once all body motion has been brought to a stop, the body can be repositioned or reoriented using a jerk-limited profile 910 as shown in FIG. 9. The acceleration profile assumes zero initial and zero final velocities. The acceleration is profiled in the world frame and the angular acceleration is profiled using the Euler rate transformation method in the body frame. This is shown in Equations FF through HH:

$$\begin{matrix}\text{Equation FF:} & \\ {\vec{r}}_{cm\_cmd}^{W} = {\vec{r}}_{cm\_final}^{W} - {\vec{r}}_{cm\_initial}^{W} \\ {C}_{W}^{c m} ≡ C ( {θ}_{x} ) C ( {θ}_{y} ) C ( {θ}_{z} ) ⇒ extract euler angles from defined sequence \\ \vec{θ} = {[ \begin{matrix}{θ}_{x} & {θ}_{y} & {θ}_{z}\end{matrix} ]}^{T} \\ {\vec{θ}}_{cmd} = {\vec{θ}}_{final} - {\vec{θ}}_{initial} \\ {\vec{a}}_{cm\_cmd \_max}^{W} = \frac{2}{( {( {t}_{6} - {t}_{0} )}^{2} / 2 + 2 {t}_{j}^{2} - 2 {t}_{j} ( {t}_{6} - {t}_{0} ) )} {\vec{r}}_{cm\_cmd}^{W} \\ {\ddot{\vec{θ}}}_{cmd\_max} = \frac{2}{( {( {t}_{6} - {t}_{0} )}^{2} / 2 + 2 {t}_{j}^{2} - 2 {t}_{j} ( {t}_{6} - {t}_{0} ) )} {\vec{θ}}_{cmd} ⇒ max euler acc . cmd & \\ \text{Equation GG:} & \\ {\vec{a}}_{cm\_cmd \_max}^{W} = \frac{2}{( {( {t}_{6} - {t}_{0} )}^{2} / 2 + 2 {t}_{j}^{2} - 2 {t}_{j} ( {t}_{6} - {t}_{0} ) )} {\vec{r}}_{cm\_cmd}^{W} \\ {\ddot{\vec{θ}}}_{cmd\_max} = \frac{2}{( {( {t}_{6} - {t}_{0} )}^{2} / 2 + 2 {t}_{j}^{2} - 2 {t}_{j} ( {t}_{6} - {t}_{0} ) )} {\vec{θ}}_{cmd} \\ for ( time \leq {t}_{1} ) \\ {\vec{a}}_{cm\_cmd}^{W} = ( {\vec{a}}_{cm\_cmd \_max}^{W} / {t}_{j} ) ( time - {t}_{0} ) \\ {\ddot{\vec{θ}}}_{cmd} = ( {\ddot{\vec{θ}}}_{cmd\_max} / {t}_{j} ) ( time - {t}_{0} ) \\ for ( {t}_{1} \leq time \leq {t}_{2} ) \\ {\vec{a}}_{cm\_cmd}^{W} = {\vec{a}}_{cm\_cmd \_max}^{W} \\ {\ddot{\vec{θ}}}_{cmd} = {\ddot{\vec{θ}}}_{cmd\_max} \\ for ( {t}_{2} \leq time \leq {t}_{4} ) \\ {\vec{a}}_{cm\_cmd}^{W} = {\vec{a}}_{cm\_cmd \_max}^{W} - ( {\vec{a}}_{cm\_cmd \_max}^{W} / {t}_{j} ) ( time - {t}_{2} ) \\ {\ddot{\vec{θ}}}_{cmd} = {\ddot{\vec{θ}}}_{cmd\_max} - ( {\ddot{\vec{θ}}}_{cmd\_max} / {t}_{j} ) ( time - {t}_{2} ) \\ for ( {t}_{4} \leq time \leq {t}_{5} ) \\ {\vec{a}}_{cm\_cmd}^{W} = - {\vec{a}}_{cm\_cmd \_max}^{W} \\ {\ddot{\vec{θ}}}_{cmd} = - {\ddot{\vec{θ}}}_{cmd\_max} \\ for ( {t}_{5} \leq time \leq {t}_{6} ) \\ {\vec{a}}_{cm\_cmd}^{W} = - {\vec{a}}_{cm\_cmd \_max}^{W} + ( {\vec{a}}_{cm\_cmd \_max}^{W} / {t}_{j} ) ( time - {t}_{5} ) \\ {\ddot{\vec{θ}}}_{cmd} = {\ddot{\vec{θ}}}_{cmd\_max} + ( {\ddot{\vec{θ}}}_{cmd\_max} / {t}_{j} ) ( time - {t}_{5} ) & \\ \text{Equation HH:} \\ \begin{matrix}{\vec{α}}_{c m / W\_cmd}^{c m} = [ \begin{matrix}{\ddot{\vec{θ}}}_{cmd} ( 1 , 1 ) \\ 0 \\ 0\end{matrix} ] + \\ C ( {θ}_{x} ) [ \begin{matrix}0 \\ {\ddot{\vec{θ}}}_{cmd} ( 2 , 1 ) \\ 0\end{matrix} ] + C ( {θ}_{x} ) C ( {θ}_{y} ) [ \begin{matrix}0 \\ 0 \\ {\ddot{\vec{θ}}}_{cmd} ( 3 , 1 )\end{matrix} ]\end{matrix} & \end{matrix}$$

It is useful to transform the angular acceleration command into the body frame because the inertial tensor is in the body frame.

Completing an Asymmetrical Gait for a Quadrupedal AWIMR

FIG. 10 is a table identifying a sequence 1000 of method steps which may be used to execute an asymmetrical gait for the quadrupedal robot 310 of FIGS. 3 and 6-7, as may be performed by a controller 100 constructed according to the present invention. FIGS. 11-16 are simplified schematic depictions of the positions of robot 310 and the feet thereof as the robot 310 carries out the sequence 1000 (steps 1010-1062) of FIG. 10. The sequence for the asymmetrical quadrupedal gait was implemented in a computer simulation to verify the design of the movement/force controller 100 and its ability to negotiate asymmetrical loading on the robot 150. The gait cycle takes 10 simulated seconds to complete for a walking speed of 18 inches per minute or a step distance of 3 inches per gait cycle.

The body orientation and position are dynamically moving during the gait cycle. This dynamic compliance is the key to ensuring that the robot foot pads maintain traction as the robot asymmetrically pulls-off and preloads foot pads during the zero-g walk.

The sequence begins at time=0 seconds, with step 1010, in which the movement/force controller 100 advances leg 318. The initial state of the robot 310 at time=0 second is depicted in FIG. 11. Step 1010 comprises a number of sub-steps executed by the controller 100. In sub-step 1012, the controller lifts leg 318, balancing forces using Solution A as earlier described. In sub-step 1014, the controller stops the body reaction motion using Solutions D and F. In sub-step 1016, the controller moves leg 318 forward, using Solution C. In sub-step 1018, the controller preloads leg 318, using Solution B. In sub-step 1020, the controller stops the body reaction motion using Solutions E and F. The state of the robot 310 upon completion of step 1010, at time=2 seconds, is depicted in FIG. 12.

The sequence continues at time=2 seconds, with step 1022, in which the movement/force controller 100 advances leg 324. Step 1022 comprises a number of sub-steps executed by the controller 100. In sub-step 1024, the controller lifts leg 324, balancing forces using Solution A as earlier described. In sub-step 1026, the controller stops the body reaction motion using Solutions D and F. In sub-step 1028, the controller moves leg 324 forward using Solution C. In sub-step 1030, the controller preloads leg 324 using Solution B. In sub-step 1032, the controller stops the body reaction motion using Solutions E and F. The state of the robot 310 upon completion of step 1022, at time=4 seconds, is depicted in FIG. 13.

The sequence continues at time=4 seconds, with step 1034, in which the movement/force controller 100 advances leg 316. Step 1034 comprises a number of sub-steps executed by the controller 100. In sub-step 1036, the controller 100 lifts leg 316, balancing forces using Solution A as earlier described. In sub-step 1038, the controller 100 stops the body reaction motion using Solutions D and F. In sub-step 1040, the controller 100 moves leg 316 forward using Solution C. In sub-step 1042, the controller 100 preloads leg 316 using Solution B. In sub-step 1044, the controller 100 stops the body reaction motion using Solutions E and F. The state of the robot 310 upon completion of step 1034, at time=6 seconds, is depicted in FIG. 14.

The sequence continues at time=6 seconds, with step 1046, in which the movement/force controller 100 advances leg 322. Step 1046 comprises a number of sub-steps executed by the controller 100. In sub-step 1048, the controller 100 lifts leg 322, balancing forces using Solution A as earlier described. In sub-step 1050, the controller 100 stops the body reaction motion using Solutions D and F. In sub-step 1052, the controller 100 moves leg 322 forward using Solution C. In sub-step 1054, the controller 100 preloads leg 322 using Solution B. In sub-step 1056, the controller 100 stops the body reaction motion using Solutions E and F. The state of the robot 310 upon completion of step 1046, at time=8 seconds, is depicted in FIG. 15.

The sequence continues at time=8 seconds, with step 1058, in which the controller 100 advances the robot body 312. Step 1058 comprises one sub-step executed by the controller 100. In sub-step 1060, the controller 100 moves the robot body 312 forward and restores its orientation, balancing forces using Solutions E and G as earlier described. The sequence concludes at time=10 seconds, with step 1062, at which the controller has now completed one gait cycle. The state of the robot 310 upon completion of step 1058, at time=10 seconds, is depicted in FIG. 16.

The steps or operations described herein are just for example. There may be many variations to these steps or operations without departing from the spirit of the invention. For instance, the steps may be performed in a differing order, or steps may be added, deleted, or modified.

Thus, there has been described a controller and associated methods for use with a multi-legged robot intended for use in low-, micro-, or zero-gravity environments. The robot may be removably attached to a supporting surface using adhesive foot pads of limited adhesive strength. The controller dynamically balances all external forces and moments on the robot using least-square techniques. When the forces and moments cannot be perfectly balanced, residual forces and moments may act on the robot causing robot body movement or positions that deviate from the desired movement/position profile. The controller continues to balance the forces over time, such that they, and the resulting movement, decay to minimal amounts. Due to redundancy, the controller may not be able to directly determine a least-square solution that incorporates all controlled parameters for all legs. In that case, the controller decomposes the system into a plurality of individual problems which are determinate, and then combines the results to achieve a solution covering the entire system. The controller and associated methods advantageously provide improved safety and stability of the robot, minimizing or eliminating the risk that force applied by the robot to one leg will cause the inadvertent detachment of other legs. In addition, the controller and associated methods provide improved stability for a robot traversing uneven or irregular surfaces. Further, the controller and associated methods can balance essentially all external forces (within mechanical limits) including those not arising from the robot's intentional travel. For example, forces arising from use of the robot's end-effector tool may be dynamically balanced, providing improved safety and stability.

Although this invention has been described as it could be applied to a control system for a multi-legged robot. These are merely examples of ways in which the invention may be applied; the invention is not limited to these examples, and could be applied to many other environments.

The embodiments described herein are examples. Thus it will be appreciated that although the embodiments are described in terms of specific technologies, other equivalent technologies could be used to implement systems in keeping with the spirit of the present invention.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A controller for a robot, comprising:
a logic implementation component;
said logic implementation component being coupled to at least one sensor for receiving therefrom information describing state of the robot;
said logic implementation component being operatively coupled to at least one actuator driving a structural component of the robot;
said logic implementation component being adapted to determine at least one optimized limb state command for said actuator responsive to said information describing state of the robot,
wherein the robot is subject to a plurality of external forces and at least one system constraint, and said logic implementation component is adapted to determine said optimized limb state command such that net external forces, including any forces produced by said robot, closely approximate a set-point defining intended net forces on the robot while said at least one system constraint is satisfied.

2. The controller of claim 1, further comprising:
a component responsive to said information from said at least one sensor for determining position, orientation, and rate of change of position, of the robot.

3. The controller of claim 2, further comprising:
a component responsive to said determined position, orientation, and rate of change of position, for determining forces and moments acting on said robot.

4. The controller of claim 1 wherein said state information includes a measurement of force applied on at least one foot of said robot.

5. The controller of claim 1, further comprising:
a component adapted to establish a command profile defining an intended linear position, velocity, and acceleration for the robot.

6. The controller of claim 1, further comprising:
a component adapted to establish a command profile defining an intended angular position, velocity, and acceleration for the robot.

7. The controller of claim 1, further comprising:
a component responsive to said information from said at least one sensor for determining position, orientation, and rate of change of position, of the robot;
a component responsive to said determined position, orientation, and rate of change of position, for determining forces and moments acting on said robot;
a component adapted to establish a command profile defining an intended linear position, velocity, and acceleration for the robot;
a component responsive to said determined forces and moments acting on said robot and said command profile for determining an optimized state profile to be executed by said robot, with respect to a center of mass thereof, that closely approximates said established command profile and balances said external forces.

8. The controller of claim 7, wherein said robot has a plurality of actuated legs, said controller further comprising;
a component responsive to said determined body forces and moments and said optimized state profile to determine for each of said plurality of legs an optimized limb state command to be applied to such leg, such that said optimized limb state commands taken in combination would achieve an effect closely approximating said optimized state profile.

9. The controller of claim 7, wherein said controller is adapted to employ least-square error minimization to balance said external forces such that said state of said robot closely approximates said intended command profile.

10. The controller of claim 7, wherein said controller is adapted to employ least-square error minimization to balance said external forces such that said robot exhibits an acceleration approximating an acceleration parameter defined in said intended command profile.

11. The controller of claim 1, wherein said robot is subject to a number of external forces rendering a least-square error minimization involving all of said forces indeterminate, and said controller is further adapted to balance said external forces by means of least-square error minimization using at least two different subsets of said forces.

12. The controller of claim 11 wherein said controller is further adapted to combine via superposition results of said least square error minimization using each of said at least two different subsets of said forces.

13. A controller for a robot, comprising:
a logic implementation component;
said logic implementation component being coupled to at least one sensor for receiving therefrom information describing state of the robot;
said logic implementation component being operatively coupled to at least one actuator driving a structural component of the robot;
said logic implementation component being adapted to determine at least one optimized limb state command for said actuator responsive to said information describing state of the robot,
wherein the robot is independently mobile and is subject to a plurality of external forces, and said logic implementation component is adapted to determine said optimized limb state command such that net external forces, including any forces produced by said robot, closely approximate a set-point defining intended net forces on the robot.

14. The controller of claim 13 wherein the robot is subject to at least one system constraint, and said logic implementation component is adapted to determine said optimized limb state command such that net external forces, including any forces produced by said robot, closely approximate a set-point defining intended net forces on the robot while said at least one system constraint is satisfied.

15. A robot comprising:
a body;
a plurality of limbs coupled to said body;
for each such limb, at least one actuator coupled to said limb for enabling said limb to apply an external force with respect to the body;
a controller coupled to said actuators and controlling an amount of external force applied by said limb;
said robot being subject to external forces including those applied by said limbs, and at least one system constraint;
said controller being adapted to determine an amount of force to be applied by each limb such that said external forces to which said robot is subject are balanced while said at least one system constraint is satisfied.

16. The robot of claim 15 wherein said robot is subject to gravitational force of an amount and in a direction, and said controller is adapted to determine an amount of force to be applied by each limb such that said external forces to which said robot is subject are balanced despite the amount and direction of said gravitational force.

17. The robot of claim 15 wherein said robot is subject gravitational force of an amount and in a direction, and said controller is adapted to determine an amount of force to be applied by each limb such that said external forces to which said robot is subject are balanced when the amount of gravitational force to which said robot is subject is less than that experienced on Earth's surface.

18. The robot of claim 15 wherein said controller is adapted to determine an amount of force to be applied by each limb using least-squares error minimization, such that said external forces are balanced.

19. The robot of claim 15 wherein:
said robot is subject to at least one system constraint;
said controller is adapted to establish an command profile defining an intended linear position, velocity, and acceleration for the robot, and responsive thereto, for issuing a state profile defining a state to which said robot is to be controller, said system constraint precluding said controller from issuing a state profile identical to said command profile; and
said controller is further adapted to issue a state profile balancing said external forces while said at least one constraint is satisfied.

20. The robot of claim 15, wherein:
at least one of said limbs of said robot further comprises a foot pad having an underside surface;
said underside surface has an adhesive allowing disengagable adhesive attachment of said foot pad to a surface;
said adhesive has limited adhesive strength; and
said controller is adapted to determine an amount of force to be applied by each limb using least-squares error minimization without exceeding said limited adhesive strength.

21. The robot of claim 15, wherein:
each of said limbs of said robot further comprises a foot pad having an underside surface;
each said underside surface has an adhesive allowing disengagable adhesive attachment of said foot pad to a surface;
each said foot pad is attached to a surface;
said adhesive has limited adhesive strength; and
said controller is adapted to determine an amount of force to be applied by each limb using least-squares error minimization to cause one foot pad to be detached from the surface without detaching any other foot pad.

22. The robot of claim 15, further comprising an end effector, wherein said controller is further adapted to determine an amount of force to be applied by each limb such that said external forces to which said robot is subject are balanced when said end-effector is in use.

23. A method for controlling a multi-legged robot comprising the steps of:
receiving from sensors of the robot information describing current state of said robot;
establishing an intended command profile of said robot defining an intended state of said robot;
establishing at least one system constraint with respect to a controlled parameter which the controller by policy should not exceed;
responsive to said sensor information and said intended command profile, determining force commands for actuators of said robot to control the external forces applied by the robot via at least one leg of said, such that said robot exhibits a state closely approximating the intended state defined in said command profile, while satisfying said at least one system constraint.

24. The method of claim 23, further comprising the step of:
applying least squares minimization when determining said force commands.

25. The method of claim 23, further comprising the step of:
applying least squares minimization when determining said force commands, such that external forces acting on said robot are balanced.

26. The method of claim 23, further comprising the step of:
decomposing an indeterminate least squares minimization problem into two or more non-identical least squares minimization problems involving fewer forces than the indeterminate problem.

27. The method of claim 26, further comprising the step of:
combining the results of the two or more problems using superposition to obtain a solution to the original problem.
